(19) United States
(12) Patent Application Publication
(10) Pub. No.: US 2023/0198723 A1
(43) Pub. Date: Jun. 22, 2023

(54) TECHNOLOGIES IN WIRELESS COMMUNICATIONS IN CONSIDERATION OF HIGH-SPEED VEHICLE

(71) Applicant: Apple Inc., Cupertino, CA (US)

(72) Inventors: Haitong Sun, Cupertino, CA (US); Chunxuan Ye, San Diego, CA (US); Dawei Zhang, Saratoga, CA (US); Hong He, San Jose, CA (US); Manasa Raghavan, Sunnyvale, CA (US); Seyed Ali Akbar Fakoorian, San Diego, CA (US); Wei Zeng, Saratoga, CA (US); Weidong Yang, San Diego, CA (US); Yushu Zhang, Beijing (CN)

(73) Assignee: Apple Inc., Cupertino, CA (US)

(21) Appl. No.: 18/072,415

(22) Filed: Nov. 30, 2022

Related U.S. Application Data
(60) Provisional application No. 63/291,277, filed on Dec. 17, 2021.

(51) Int. Cl. H04L 5/00; H04B 7/01; H04W 72/542

(52) U.S. Cl. CPC H04L 5/0053; H04B 7/01; H04W 72/542

(57) ABSTRACT

The present application relates to devices and components including apparatus, systems, and methods to address Doppler shift in wireless communication systems.

### CROSS-REFERENCE TO RELATED APPLICATION

This application claims priority to U.S. Provisional Patent Application No. 63/291,277, entitled “TECHNOLOGIES IN WIRELESS COMMUNICATIONS IN CONSIDERATION OF HIGH-SPEED VEHICLE”, filed on Dec. 17, 2021, the disclosure of which is incorporated by reference herein in its entirety for all purposes.

### BACKGROUND

User equipment (UE) and transmit and reception points (TRPs) in Third Generation Partnership Project (3GPP) networks rely on scheduling of communications for proper interpretation of data being exchanged between the UE and the TRPs. Generally, the scheduling of the communications result in the communications or opportunities for communication being scheduled at uniform time intervals, such as being scheduled at a certain frequency.

However, as either of the UE and/or the TRP is moved, the times at which the communications are received at the receiving UE or TRP may differ from the uniform time intervals and/or the frequency at which the receiving UE or TRP is expecting to receive the communications. For example, as the UE and/or the TRP is moved, the Doppler effect caused by the movement may cause a frequency difference between the frequency that a transmitting device transmits communications and the frequency at which the receiving device receives the communications.

### BRIEF DESCRIPTION OF THE DRAWINGS

FIG. 1 illustrates an example of network arrangement with a high speed vehicle (HSV) situation in accordance with some embodiments.

FIG. 2 illustrates an example signal flow that can support approach 1.1, approach 1.2, and/or approach 1.3 in accordance with some embodiments.

FIG. 3 illustrates an example network arrangement that illustrates the synchronization signal/physical broadcast channel block (SSB) association approach of approach 1.4 in accordance with some embodiments.

FIG. 4 illustrates an example signal flow for approach 1.4 in accordance with some embodiments.

FIG. 5 illustrates an example signal flow that can support approach 2.1, approach 2.2, approach 2.3, and/or approach 2.4 in accordance with some embodiments.

FIG. 6 illustrates an example signal flow for approach 2.5 in accordance with some embodiments.

FIG. 7 illustrates an example network arrangement showing the configuration of approach 3.1 in accordance with some embodiments.

FIG. 8 illustrates an example network arrangement showing the configuration of approach 3.2 in accordance with some embodiments.

FIG. 9 illustrates an example procedure in accordance with some embodiments.

FIG. 10 illustrates an example procedure in accordance with some embodiments.

FIG. 11 illustrates an example procedure in accordance with some embodiments.

FIG. 12 illustrates an example procedure in accordance with some embodiments.

FIG. 13 illustrates example beamforming circuitry in accordance with some embodiments.

FIG. 14 illustrates an example user equipment (UE) in accordance with some embodiments.

FIG. 15 illustrates an example next generation NodeB (gNB) in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

Issue Statement

High Speed Vehicle (HSV) is a deployment scenario a few operators are very interested in, especially for operators from China such as China Mobile Communications Corporation (CMCC). HSV may be defined as any user equipment that is moving at a high rate of speed. For example, HSV may comprise a user equipment moving at 350 kilometers per hour (km/h) or higher. In some embodiments, the HSV may include high speed train (HST). HSV enhancement has been considered for release 17 (Rel-17) further enhanced multiple input multiple output (FeMIMO).

The UE (such as a train with wireless communication capabilities or another UE capable of transportation at a high rate of speed) travels between 2 transmission and reception point (TRP) in HSV scenarios. UE can observe very high positive Doppler shift from one TRP, and very high negative Doppler shift from the other TRP. As results, the composite channel can vary very fast, close to or more than 2 kilohertz (kHz). This can potentially reduce the channel capability or make it very challenging for UE to perform accurate channel estimation.

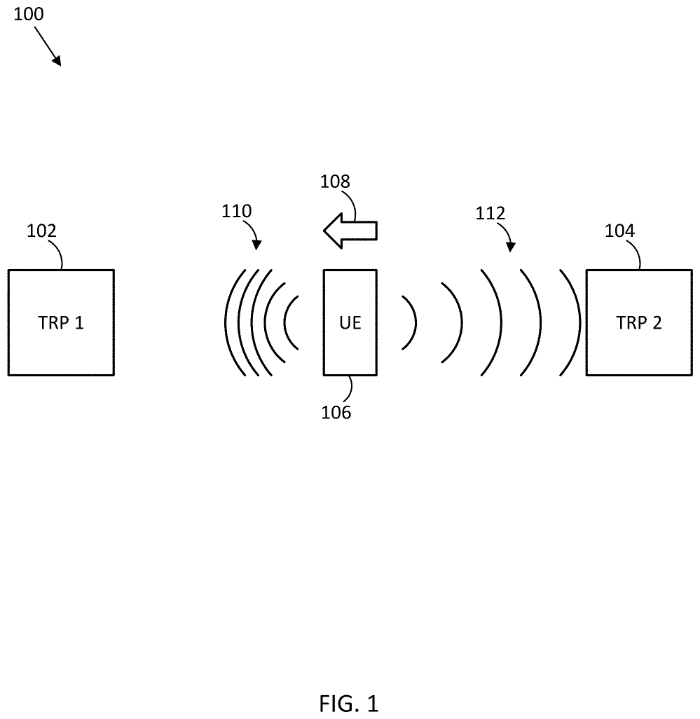

FIG. 1 illustrates an example of network arrangement 100 with a HSV situation in accordance with some embodiments. The illustrated network arrangement 100 provides an example illustration of Doppler shift that may occur when a HSV situation is presented. In particular, the HSV situation may be presented when an element of a network is traveling at a high rate of speed as compared to other elements of the network with which the element is to communicate. In some embodiments, the rate of speed difference between the element and the other elements of the network may be equal to or greater than 350 km/h.

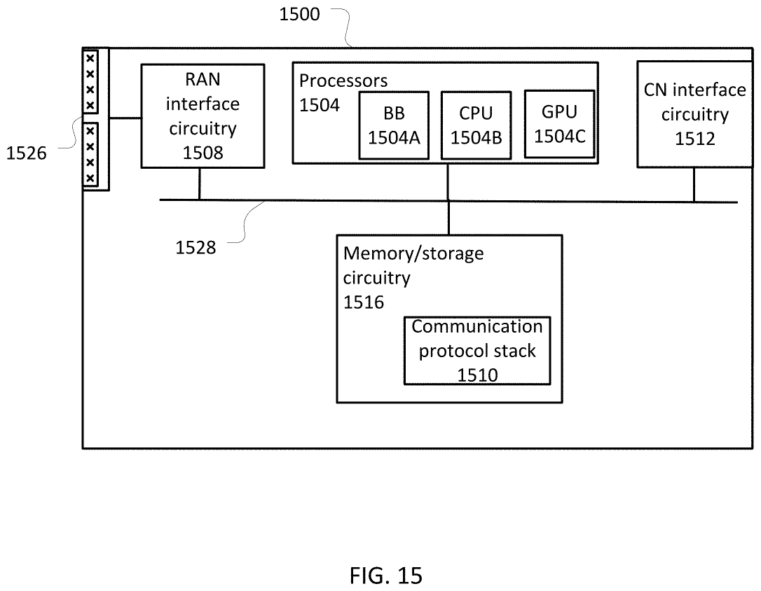

The network arrangement 100 may include one or more TRPs. For example, the network arrangement 100 shows a first TRP 102 and a second TRP 104 in the illustrated embodiment. The first TRP 102 and/or the second TRP 104 may comprise a portion of a network that can be utilized to wirelessly communicate with UEs. For example, the first TRP 102 and/or the second TRP 104 may comprise a NodeB (such as a NodeB, an evolved NodeB (eNB), a next generation NodeB (gNB), or some combination thereof). In some instances, the first TRP 102 and/or the second TRP 104 may comprise a wirelessly enabled device that may route signals between a NodeB and a UE. Each of the first TRP 102 and/or the second TRP 104 may include one or more of the features of the gNB 1500 (FIG. 15) in some embodiments.

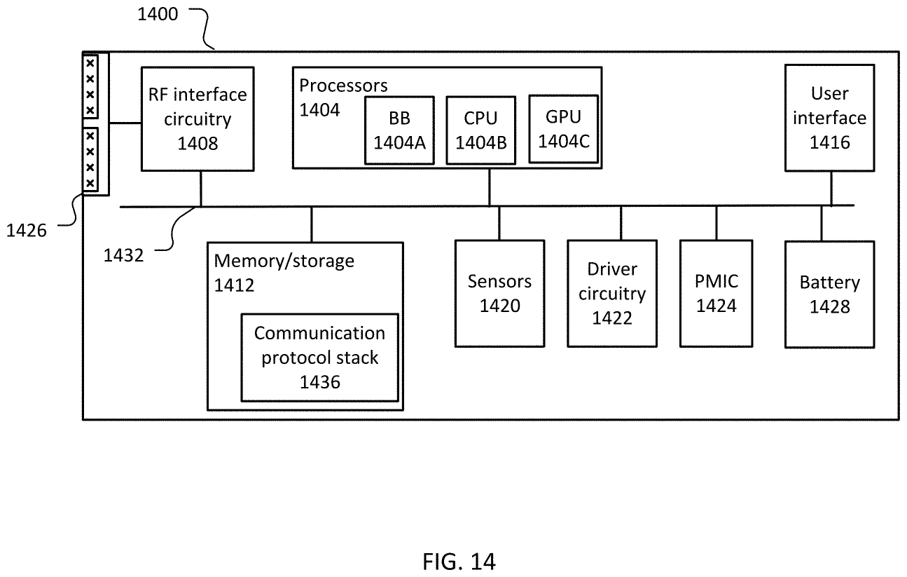

The network arrangement 100 may further include one or more UEs. For example, the network arrangement 100 shows a UE 106 in the illustrated embodiment. The UE 106 may wirelessly communicate with the first TRP 102 and/or the second TRP 104. In particular, the UE 106 may utilize the first TRP 102 and/or the second TRP 104 to communicate with the network. The UE 106 may include one or more of the features of the UE 1400 (FIG. 14) in some embodiments.

In the illustrated embodiment, the UE 106 may be traveling at a high speed, as indicated by arrow 108. In particular, the UE 106 is shown traveling at a high speed relative to the first TRP 102 and the second TRP 104 in the illustrated embodiment, where the UE is traveling toward the first TRP 102 and away from the second TRP 104. The speed at which the UE 106 is traveling may be greater than or equal to 350 km/h relative to the first TRP 102 and the second TRP 104 in some embodiments. For example, the first TRP 102 and the second TRP 104 may be stationary, whereas the UE 106 is moving toward the first TRP 102 and away from the second TRP 104 at a speed of greater than or equal to 350 km/h.

Due to the rate of speed that the UE 106 is traveling relative to the first TRP 102 and the second TRP 104, a Doppler shift may affect signals transmitted among the first TRP 102, the second TRP 104, and the UE 106. For illustration of the Doppler shift that may affect the signals, the network arrangement 100 illustrates a set of signals emitted from the UE 106, which are represented by first set of lines 110 directed toward the first TRP 102 and second set of lines 112 directed toward the second TRP 104. The set of signals may have been omitted from the UE 106 at a uniform frequency. However, due to the movement of the UE 106, the Doppler shift may cause the signals to be condensed in terms of space in a direction toward which the UE 106 is moving and expanded in terms of space in a direction from which the UE 106 is traveling. In particular, the first set of lines 110 representing the set of signals are shown closer together to illustrate the effect of the positive Doppler shift on the set of signals in the direction that the UE 106 is moving toward and the second set of lines 110 representing the set of signals are shown farther apart to illustrate the negative Doppler shift on the set of signals in the direction that the UE 106 is moving away from.

Without compensation, an element receiving a signal may expect to be receiving the signal at the same frequency that the element has transmitted the signals. For example, the first TRP 102 and the second TRP 104 may expect to receive the signals transmitted by the UE 106 at the frequency which the UE 106 transmitted the signals. However, due to the Doppler shift the frequency of the signals received by the first TRP 102 and the second TRP 104 may differ from the frequency at which the UE 106 emitted the signals. The first TRP 102 and the second TRP 104 may have issues processing the signals due to the uncompensated Doppler shift.

Approaches may be utilized by the elements to compensate for Doppler shift to prevent and/or reduce the chance that errors will occur in transmission and/or processing of the signals. In general, there are two approaches. A first approach, which may be referred to as high speed vehicle (HSV)-single frequency network (SFN) scheme 1 may allow a UE to estimate two separate Doppler shifts, one from each TRP. This may be used to assist UE channel estimation. For example, the HSV-SFN scheme 1 may cause the UE 106 to estimate a first Doppler shift between the first TRP 102 and the UE 106, and a second Doppler shift between the second TRP 104 and the UE 106. The UE 106 may utilize the estimated Doppler shifts in transmitting signals to and/or processing signals from the first TRP 102 and/or the second TRP 104. In other embodiments, the UE 106 may provide the estimated Doppler shifts to the first TRP 102 and/or the second TRP 104 for compensating for the Doppler shifts. HSV, as used herein, may refer to a high-speed train (HST) or other vehicle or mechanism for transporting a UE. Thus, in some embodiments, the HSV-SFN scheme 1 may include HST-SFN scheme 1.

A second approach for addressing Doppler shifts includes HSV-SFN with pre-compensation. This approach may allow network (NW) to pre-compensate for the Doppler shift. The NW may need to know the Doppler shift. For example, first TRP 102 and/or the second TRP 104 (and/or the network of which the first TRP 102 and/or the second TRP 104 are part of) may estimate the Doppler shifts between the first TRP 102 and the UE 106, and between the second TRP 104 and the UE 106. The first TRP 102 and/or the second TRP 104 (and/or the network of which the first TRP 102 and/or the second TRP 104 are part of) may utilize the Doppler shifts in transmitting signals to and/or processing signals from the UE 106.

Two modes of HSV enhancement may be supported in Third Generation Partnership Project (3GPP) Rel-17 new radio (NR). A first mode may be HSV-SFN mode 1. In HSV-SFN mode 1, the NW does not perform Doppler shift pre-compensation. Further in HSV-SFN mode 1, a physical downlink control channel (PDCCH)/physical downlink shared channel (PDSCH)/demodulation reference signal (DMRS) can be transmitted based on SFN operation. A second mode may be HSV-SFN with NW pre-compensation. In the HSV-SFN with NW pre-compensation mode, NW performs Doppler shift pre-compensation. Further in the HSV-SFN with NW pre-compensation mode, PDSCH/DMRS can be transmitted based on single frequency network (SFN) operation.

Approaches disclosed herein may provide design details for HSV-SFN scheme 1 and pre-compensation. In a first approach, design for HSV-SFN scheme 1 is disclosed. In a second approach, design for HSV-SFN with pre-compensation is disclosed. In a third approach, group based transmission configuration indicator (TCI) update is disclosed.

### Approach 1: Design for HSV-SFN Scheme 1

A first group of approaches presented herein may relate to the HSV-SFN scheme 1 design. For example, the approaches may be utilized for configuring a UE (such as the UE 106) to perform HSV-SFN scheme 1 to compensate for Doppler shifts. The UE may be configured to estimate one or more Doppler shifts associated with TRPs and utilize the estimated Doppler shifts to compensate for the Doppler shifts.

As described further throughout this disclosure, a single-TRP approach may be configured by the UEs and/or the network. In the single-TRP approach, the UE may communicate with a single TRP rather than communication with two TRPs as implemented by the HSV-SFN scheme 1. Further, UEs may support or may not support dynamic switching. Dynamic switching may comprise switching from a first state in one slot to another state in a next slot. For example, dynamic switching may comprise switching from HSV-SFN scheme 1 in one slot to single-TRP in the next slot, or vice versa.

Approach 1.0: For PDSCH, radio resource control (RRC) parameter is used to configure the UE to operate in HSV-SFN scheme 1. For example, a network and/or a TRP (such as the first TRP 102 (FIG. 1) and/or the second TRP 104 (FIG. 1)) of the network may provide an RRC communication to the UE to configure the UE to operate in HSV-SFN scheme 1, where the RRC communication can include the RRC parameter. Option 1: RRC parameter is configured per component carrier (CC) for PDSCH. For example, the RRC parameter provided to the UE may define parameters for HSV-SFN scheme 1 on a per CC basis, where the UE may configure each CC in accordance with a corresponding RRC parameter. Different CCs may correspond to different RRC parameters. In option 1, Dynamic bandwidth part (BWP) switching may not be used to change the PDSCH operation mode, only RRC reconfiguration can be used to change the PDSCH operation mode. Option 2: RRC parameter is configured per BWP per CC for PDSCH. For example, the RRC parameter provided to the UE may define parameters for HSV-SFN scheme 1 on a per BWP basis, where the UE may configure each BWP in accordance with a corresponding RRC parameter. Different BWPs may correspond to different RRC parameters. In option 2, Dynamic BWP switching can be used to change the PDSCH operation mode.

Approach 1.1: For PDSCH TCI codepoint activation. In particular, approach 1.1 may be utilized for TCI codepoint activation for a PDSCH. If RRC parameter is used to configure the UE to operate in HSV-SFN scheme 1 per CC, in all the BWP configured in the corresponding CC. For example, the RRC parameter may cause a UE to configure all BWPs within a same CC corresponding to the RRC parameter with HSV-SFN scheme 1 or single-TRP. Different CCs may be configured with different schemes, such that all CCs may be configured with HSV-SFN scheme 1, all CCs may be configured with single-TRP, or a portion of the CCs may be configured with HSV-SFN scheme 1 and another portion of the CCs may be configured with single-TRP. If RRC parameter is used to configure the UE to operate in HSV-SFN scheme 1 per BWP per CC, in the corresponding BWP configured in the corresponding CC. For example, the RRC parameter may cause a UE to configure a BWP corresponding to the RRC parameter with HSV-SFN scheme 1 or single-TRP. Different BWPs may be configured with different schemes, such that all BWPs may be configured with HSV-SFN scheme 1, all BWPs may be configured with single-TRP, or a portion of the BWPs may be configured with HSV-SFN scheme 1 and another portion of the BWPs may be configured with single-TRP. In some embodiments, the base station can configure up to four BWPs in a CC. Each of the BWPs within the CC may be configured with the same scheme or may be configured with different schemes.

The following are the restriction on the PDSCH TCI codepoint activation. For example, the PDSCH TCI codepoint activation of approach 1.1 may have the following features. If UE does not support dynamic switching between HSV-SFN scheme 1 and single-TRP, NW can only use medium access control-control element (MAC-CE) to activate a TCI codepoint with two TCI States. For example, the UE may indicate to a network or a TRP of the network that the UE does not support dynamic switching. Based on the indication that the UE does not support dynamic switching, the network may limit activation of the TCI codepoint to two TCI states. The network may provide MAC-CE to the UE to activate the TCI codepoint with the two TCI states. Otherwise, if UE supports dynamic switching between HSV-SFN scheme 1 and single-TRP, NW can use MAC-CE to activate a TCI codepoint with either one TCI State or two TCI States. For example, the UE may indicate to a network or a TRP of the network that the UE supports dynamic switching. Based on the indication that the UE supports switching, the network may activate the TCI codepoint with one TCI state or two TCI states.

Approach 1.2: Regarding the UE capability supporting HSV-SFN scheme 1 for PDCCH, whether UE support. For example, approach 1.2 may be applied when HSV-SFN scheme 1 is supported by the UE for PDCCH. In some embodiments, approach 1.2 may further be based on whether the UE supports mixed operation of control resource sets (CORESETs) for application of approach 1.2. In approach 1.2, the CORESETs in an active BWP may be configured with different numbers of TCI states. In some CORESET in the active BWP, only single TCI State is activated by MAC-CE. In some CORESET in the active BWP, two TCI States is activated by MAC-CE. For example, the network and/or TRP (such as the first TRP 102 (FIG. 1) and/or the second TRP 104 (FIG. 1)) may provide a MAC-CE to the UE that causes the UE to configure corresponding CORESETs with a single TCI state or two TCI states. The MAC-CE may cause the UE to configure all CORESETs in the active BWP with a single TCI state, all CORESETs in the active BWP with two TCI states, or a first portion of the CORESETs in the active BWP with a single TCI and a second portion of the CORESETs in the active BWP with two TCI states. The MAC-CE may configure up to three CORESETs within each BWP in some embodiments, where the CORESETs may be configured with different numbers of TCI states.

Following are the options for approach 1.2. Option 1: It is UE optional feature and UE can report whether UE supports this when UE supports HSV-SFN scheme 1 for PDCCH. For example, whether a UE supports HSV-SFN scheme 1 may be optional. Accordingly, some UEs may not support HSV-SFN scheme 1 in some instances. The UEs may transmit a signal to the network and/or a TRP of the network to indicate whether the UE supports HSV-SFN. In some embodiments, the signals transmitted by the UEs may indicate whether the UEs support mixed operation of CORESETs in addition to or in place of indicating whether the UE supports HSV-SFN scheme 1. The mixed operation of CORESETs may comprise having a portion of the CORESETs of an active BWP configured in one state (such as HSV-SFN scheme 1) and another portion of the CORESETs of the active BWP configured in another state (such as single-TRP). Option 2: For UE supports HSV-SFN scheme 1 , UE has to support mixed operation of CORESETs. For example, in option 2 all the UEs may support mixed operation of CORESETs. In instances where the UE supports mixed operation of CORESETs, the network and/or TRP of the network may cause the UE to configure a first portion of the CORESETs with HSV-SFN scheme 1 and a second portion of the CORESETs with single-TRP.

Approach 1.3: If UE indicates UE does not support mixed operation of CORESETs, for all the CORESETs configured in the active BWP in a CC NW either activates all CORESETs with two TCI States via MAC-CE, or NW activates all CORESETs with single TCI States via MAC-CE. For example, a UE may provide an indication that the UE does not support mixed operation of CORESETs. The indication may be in addition to an indication that the UE supports HSV-SFN. The network and/or a TRP of the network may determine that the UE does not support mixed operation of CORESETs based on the indication from the UE. Based on the network and/or the TRP determining that the UE does not support mixed operation, the network and/or the TRP may either cause all the CORESETs in the active BWP to be activated with two TCI states or cause all the CORESETs in the active BWP to be activated with a single TCI state. The network and/or the TRP may provide a MAC-CE to the UE to cause the UE to activate all the CORESETs in the active BWP with two TCI states or activate all the CORESETs in the active BWP with a single TCI state.

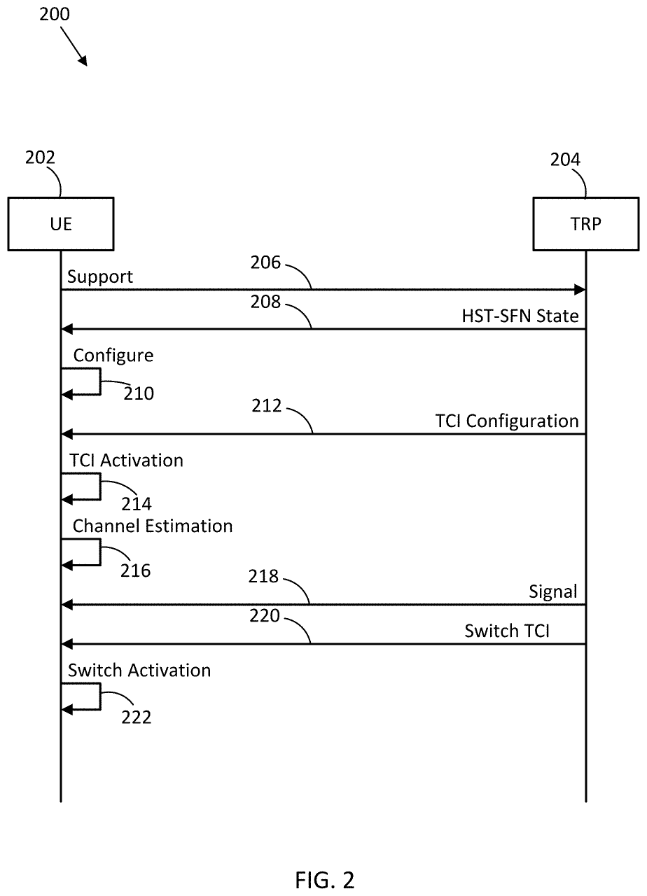

FIG. 2 illustrates an example signal flow 200 that can support approach 1.1, approach 1.2, and/or approach 1.3 in accordance with some embodiments. In particular, the signal flow 200 illustrates signals that may be exchanged between a UE 202 and a TRP 204. It should be understood that the signals in the signal flow 200 may be transmitted in different orders than shown and/or concurrently. Additionally, the signal flow 200 may omit some signals (such as acknowledgement signals and/or failure signals) that may be transmitted in configuring approach 1.1, approach 1.2, and/or approach 1.3. Further, one or more of the signals shown in the signal flow 200 may be omitted in some embodiments. The UE 202 may include one or more of the features of the UE 106 (FIG. 1). The TRP 204 may include one or more of the features of the first TRP 102 (FIG. 1) and/or the second TRP 104 (FIG. 1).

The signal flow 200 may initiate with the UE 202 transmitting a support indication 206 to the TRP 204 that indicates features supported and/or not supported by the UE 202. In some embodiments, the support indication 206 may comprise one or more UE capability reports that indicate the capabilities of the UE 202. The support indication 206 may indicate whether the UE 202 supports HSV-SFN, mixed CORESET operation, or some combination thereof. For example, the support indication 206 may include a UE capability report that indicates whether the UE 202 supports HSV-SFN and/or a UE capability report that indicates whether the UE 202 supports mixed CORESET operation. Further, the support indication 206 may include an indication of whether the UE 202 supports HSV-SFN scheme 1 in some embodiments. The support indication 206 may further include an indication of which channels and/or elements each of the features is supported. For example, the support indication 206 may indicate that the HSV-SFN, the mixed CORESET operation, and/or the HSV-SFN scheme 1 is supported for PDSCH, PDCCH, and/or CORESETs in some embodiments. In some embodiments, the UE 202 may provide the support indication 206 in response to a capability request provided by the TRP 204 to the UE 202. In other embodiments, the UE 202 may provide the support indication 206 upon joining the network (such as the UE 202 registering with the network and/or the UE 202 being powered on) and the network may store the information included in the support indication 206.

Based on the support indication 206, the network and/or the TRP 204 may determine which configurations the UE 202 is capable of supporting. For example, the network and/or the TRP 204 may determine whether the UE 202 supports HSV-SFN based on an indication of whether the UE 202 supports HSV-SFN included in the support indication 206 in some embodiments. In embodiments where the support indication 206 includes a UE capability report that indicates whether the UE 202 supports HSV-SFN, the network and/or the TRP 204 may determine whether the UE 202 supports HSV-SFN based on the UE capability report. Accordingly, the network and/or the TRP 204 may determine whether the UE 202 supports HSV-SFN for approach 1.1, approach 1.2, and/or approach 1.3. In some embodiments, the network and/or the TRP 204 may determine whether the UE 202 supports HSV-SFN scheme 1 based on an indication included in the support indication 206.

The network and/or the TRP 204 may further to determine channels (such as PDSCH and/or PDCCH) and/or elements (such as CORESETs) for which the UE 202 supports HSV-SFN and/or HSV-SFN scheme 1 based on an indication included in the support indication 206. For example, the network and/or the TRP 204 may determine whether the UE 202 supports HSV-SFN and/or HSV-SFN scheme 1 for PDSCH for approach 1.1. The network and/or the TRP 204 may determine whether the UE 202 supports HSV-SFN and/or HSV-SFN scheme 1 for PDDCH and/or CORESETs for approach 1.2 and/or approach 1.3.

For approach 1.2 and/or approach 1.3, the network and/or the TRP 204 may further determine whether the UE 202 supports mixed operation of CORESETs based on an indication included in the support indication 206. In embodiments where the support indication 206 includes a UE capability report that indicates whether the UE 202 supports mixed CORESET operation, the network and/or the TRP 204 may determine whether the UE 202 supports mixed CORESET operation based on the UE capability report.

The network and/or the TRP 204 may determine an HSV-SFN state configuration for the UE 202. In embodiments, where the support indication 206 is included, the network and/or the TRP 204 may determine an HSV-SFN state configuration based on the information within the support indication 206. The TRP 204 may provide an HSV-SFN state configuration communication 208 to the UE 202 that indicates a configuration for the UE 202. The HSV-SFN state configuration communication 208 may indicate that the UE 202 is to operate in HSV-SFN scheme 1 and/or single-TRP. For approach 1.1, the HSV-SFN state configuration communication 208 may indicate on a per CC or a per BWP per CC basis that HSV-SFN scheme 1 or single-TRP is to be configured. For example, the HSV-SFN state configuration communication 208 may indicate with which state each of the CCs is to be configured or which state each of the BWPs are to be configured for approach 1.1. For approach 1.2 and/or approach 1.3, the HSV-SFN state configuration communication 208 may indicate whether CORESETs in an active BWP are to be configured with HFT-SFN scheme 1 or single-TRP. In some embodiments, the HSV-SFN state configuration communication 208 may comprise an RRC communication.

The UE 202 may receive the HSV-SFN state configuration communication 208 and determine state configurations to be configured by the UE 202. For example, the UE 202 may determine which of HSV-SFN scheme 1 and/or single-TRP are to be configured by the UE 202. The UE 202 may further determine which of the CCs and/or BWPs are to be configured with HSV-SFN scheme 1 and/or single-TRP for approach 1.1. The UE 202 may determine which CORESETs are to be configured with HSV-SFN scheme 1 and/or single-TRP for approach 1.2 and/or approach 1.3. In 210, the UE 202 may configure itself in accordance with the states determined from the HSV-SFN state configuration communication 208. For example, the UE 202 may configure the CCs and/or the BWPs in accordance with the determined HSV-SFN scheme 1 and/or single-TRP from the HSV-SFN state configuration communication 208 for approach 1.1. For approach 1.2 and/or approach 1.3, the UE 202 may configure the CORESET in accordance with the determined HSV-SFN scheme 1 and/or single-TRP from the HSV-SFN state configuration communication 208.

The network and/or the TRP 204 may further determine TCI configuration for the UE 202. In embodiments, where the support indication 206 is included, the network and/or the TRP 204 may determine TCI configuration for the UE 202 based on the information within the support indication 206. For example, the network and/or the TRP 204 may determine that the UE 202 is to have TCI codepoint activated with two TCI states based on indication that the UE 202 does not support dynamic switching from the support indication 206 for approach 1.1. Further, the network and/or the TRP 204 may determine that the UE 202 is to have TCI codepoint activated with one TCI state or two TCI states based on indication that the UE 202 supports dynamic switching from the support indication 206 for approach 1.1. For approach 1.2 and/or approach 1.3, the network and/or the TRP 204 may determine that the UE 202 can have CORESETs activated with a mix of a single TCI state and two TCI states based on an indication that the UE 202 supports mixed operation of CORESETs in the support indication 206. Further for approach 1.2 and/or approach 1.3, the network and/or the TRP 204 may determine that the UE 202 may have all CORESETs activated with two TCI states or may have all CORESETs activated with a single TCI state based on an indication that the UE 202 does not support mixed operation of CORESETs in the support indication 206. The network and/or the TRP 204 may generate a TCI configuration communication 212 that indicates TCI configuration for the UE 202 and may provide the TCI configuration communication 212 to the UE 202. In some embodiments, the TCI configuration communication 212 may comprise a MAC-CE.

The UE 202 may determine the TCI configuration for the UE 202 based on the TCI configuration communication 212. For example, the UE 202 may determine which CCs or BWPs are to be activated with one TCI state and which CCs or BWPs are to be activated with two TCI states based on the TCI configuration communication 212 for approach 1.1. For approach 1.2 and approach 1.3, the UE 202 may determine which CORESETs are to be activated with one TCI state and which CORESETs are to be activated with two TCI states based on the TCI configuration communication 212. In 214, the UE 202 may activate the CCs, the BWPs, or the CORESETs in accordance with the determined states. For example, the UE 202 may activate each of the CCs or the BWPs with one TCI state or two TCI states in accordance with the determinations from the TCI configuration communication 212 for approach 1.1. In particular, TCI codepoints for the CCs or the BWPs may be activated with one TCI state or two TCI states. For approach 1.2 and/or approach 1.3, the UE 202 may activate the CORESETs with one TCI state or two TCI states in accordance with the determinations from the TCI configuration communication 212. In particular, TCI codepoints for the CORESETs may be activated with one TCI state or two TCI states.

In 216, the UE 202 may perform a channel estimation. For example, the UE 202 may perform the channel estimation to determine a Doppler shift based on the TCI codepoint. The UE 202 may estimate a Doppler shift that may be caused by movement of the UE 202 and/or the TRP 204. The UE 202 may utilize the estimated Doppler shift to compensate for the Doppler shift in communications. For example, the TRP 204 may transmit a signal 218 to the UE 202 and the UE 202 may utilize the determined Doppler shift estimate in decoding the signal 218. By compensating for the Doppler shift, the UE 202 may properly interpret the signal. The UE 202 may also utilize the estimated Doppler shift for compensation for signals transmitted by the UE 202 to the TRP 204.

In some instances, the TRP 204 may further provide a switch TCI communication 220 to the UE 202. The switch TCI communication 220 may indicate TCI codepoints that are to be switched and/or updated TCI configuration for the UE 202. For example, the switch TCI communication 220 may indicate that one or more TCI codepoints are to be switched from activation with one TCI state to activation with two TCI states and/or from activation with two TCI states to activation with one TCI state. The switch TCI communication 220 may indicate the CCs, BWPs, and/or the CORESETs corresponding to the TCI codepoints that are to be switched. For approach 1.1, the switch TCI communication 220 may indicate on a per CC or per BWP basis which CCs or BWPs are to have activation switched. For approach 1.2 and approach 1.3, the switch TCI communication 220 may indicate which CORESETs are to have activation switched. In 222, the UE 202 may switch the activation of the TCI codepoints in accordance with the indications in the switch TCI communication 220.

Approach 1.4: For time and frequency tracking, NW explicitly or implicitly configure the association of synchronization signal/physical broadcast channel block (SSB) with TRP. For example, the network and/or a TRP of the network may configure or provide configuration information to the UE for the UE to be able to associate SSBs with the TRPs that provide the SSBs. Implicit configuration: NW configures SSB to be the quasi co-location (QCL) source of tracking reference signal (TRS), which implicitly indicates the association between SSB and TRP since TRS is used for QCL source of PDSCH/demodulation reference signal (DMRS). For example, the network and/or the TRP may provide configuration information to the UE that causes the UE to configure a SSB as a QCL source of a TRS, which may be part of the TRS configuration. The UE may be aware of which TRS is associated with which TRP, which may be derived from QCL TCI state configuration. The UE may determine which SSB is associated with which TRP based on the SSB being configured as the QCL source of the TRS and the known association of the TRS with the TRP. Accordingly, the network and/or the TRP may implicitly configure the association of SSBs with TRPs in the implicit configuration of approach 1.4. If a SSB is not configured as QCL source of TRS used for PDSCH/DMRS QCL indication, UE cannot assume the associate of SSB with any TRP. For example, the UE may be unable to determine the source TRP of a SSB in instances where the SSB is not configured as the QCL source of the TRS.

Explicit configuration 1: When NW uses the MAC-CE to activate the TCI codepoint for PDSCH, NW configures the association of each TCI codepoint with different SSBs. For example, the network and/or a TRP of the network may provide an association between a TCI codepoint and an SSB. The network and/or the TRP may provide the association when providing activation for the TCI codepoint, such as including an indication of the association in the TCI configuration communication 212 (FIG. 2). In some embodiments, the indication of the association may include a mapping between TCI codepoints and SSBs. In some embodiments, the indication of the association may comprise a MAC-CE. The TCI codepoint may include a TRS, where the UE may be aware of with which TRP each TRS is associated. The UE may determine which SSB corresponds to which TRP based on the association between the TCI codepoint and the SSB, and the relationship between each TRS and each TRP. Accordingly, the network and/or the TRP may explicitly configure the association of SSBs with TRPs in the explicit configuration 1 of approach 1.4. For the SSBs not configured with the association, UE cannot assume the association of SSB with any TRP. For example, the UE may be unable to determine the source TRP of a SSB in instances where the SSB is not configured as the QCL source of the TRS.

Explicit configuration 2: NW independently configures for each SSB whether it is from first TRP or second TRP or none. For example, the network and/or a TRP of the network may provide a separate communication to a UE that indicates which SSBs are associated with which TRPs. The separate communication may comprise a MAC-CE or an RRC. The MAC-CE and the RRC for indication of the association may be separate from other MAC-CEs and/or RRCs utilized for configuration of the HSV-SFN state and/or the TCI configuration. In some embodiments, the indication may comprise a mapping (such as a bitmap) that indicates which SSB is associated with which TRP. Based on the separate communication, the UE may determine which SSBs are received from which TRPs.

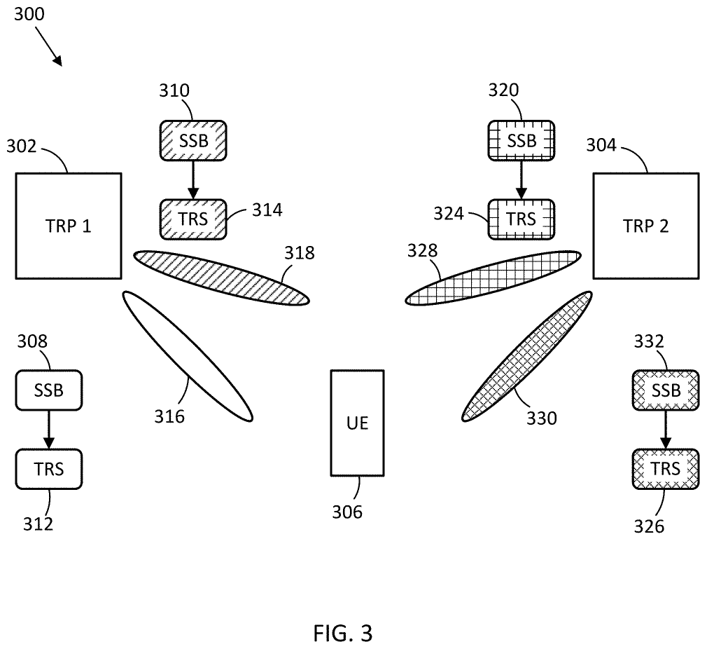

FIG. 3 illustrates an example network arrangement 300 that illustrates the SSB association approach of approach 1.4 in accordance with some embodiments. In particular, the network arrangement 300 illustrates association between SSBs and TRPs that may be configured by approach 1.4.

The network arrangement 300 may include one or more TRPs. In the illustrated embodiments, the network arrangement 300 includes a first TRP 302 and a second TRP 304. The first TRP 302 and the second TRP 304 may include one or more of the features of the first TRP 102 (FIG. 1) and/or the second TRP 104 (FIG. 1). The network arrangement 300 may further include a UE 306. The UE 306 may include one or more of the features of the UE 106.

Each of the TRPs may provide one or more SSBs and/or one or more TRSs to the UE. In the illustrated embodiment, the first TRP 302 may provide a first SSB 308 and a second SSB 310 to the UE 306. Further, the first TRP 302 may provide a first TRS 312 and a second TRS 314 to the UE 306. The first TRP 302 may provide the first SSB 308 and the first TRS 312 to the UE 306 via one or more signals, where the one or more signals may be carried in a first beam 316. The first TRP 302 may provide the second SSB 310 and the second TRS 314 to the UE 306 via one or more signals, where the one or more signals may be carried in a second beam 318.

In the illustrated embodiment, the second TRP 304 may provide a third SSB 320 and a fourth SSB 322 to the UE 306. Further, the second TRP 304 may provide a third TRS 324 and a fourth TRS 326 to the UE 306. The second TRP 304 may provide the third SSB 320 and the third TRS 324 to the UE 306 via one or more signals, where the one or more signals may be carried in a third beam 328. The second TRP 304 may provide the fourth SSB 322 and the fourth TRS 326 to the UE 306 via one or more signals, where the one or more signals may be carried in a fourth beam 330.

The network via the first TRP 302 and/or the second TRP 304 provide one or more indications to the UE 306 that can be utilized to determine which SSB is provided by which TRP. In the implicit configuration of approach 1.4, the network may configure each of the SSBs as the QCL sources for the corresponding TRSs. The network may provide, via the first TRP 302 and/or the second TRP 304, one or more TCI configuration communications (such as the TCI configuration communication 212 (FIG. 2)) to the UE 306, where the TCI configuration communications may cause the UE 306 to configure the SSBs as the QCL sources for the corresponding TRSs. In other embodiments, the UE 306 may be configured at production and/or at joining the network to determine that the SSBs configured as QCL sources of TRSs are associated with a same TRP as the TRSs for which the SSBs are configured as the QCL sources. For example, the network may configure the first SSB 308 as the QCL source of the first TRS 312. As the UE 306 is aware that the first TRS 312 is associated with the first TRP 302, the UE 306 may determine that the first SSB 308 is associated with the first TRP 302 based on the first SSB 308 being configured as the QCL source of the first TRS 312. Further, the network may configure the second SSB 310 as the QCL source of the second TRS 314. As the UE 306 is aware that the second TRS 314 is associated with the first TRP 302, the UE 306 may determine that the second SSB 310 is associated with the first TRP 302 based on the second SSB 310 being configured as the QCL source of the second TRS 314. The network may configure the third SSB 320 as the QCL source of the third TRS 324. As the UE 306 is aware that the third TRS 324 is associated with the second TRP 304, the UE 306 may determine that the third SSB 320 is associated with the second TRP 304 based on the third SSB 320 being configured as the QCL source of the third TRS 324. Further, the network may configure the fourth SSB 322 as the QCL source of the fourth TRS 326. As the UE 306 is aware that the fourth TRS 326 is associated with the second TRP 304, the UE 306 may determine that the fourth SSB 322 is associated with the second TRP 304 based on the fourth SSB 322 being configured as the QCL source of the fourth TRS 326.

In the explicit configuration 1 of approach 1.4, the network may configure association of each of the SSBs with TCI codepoints. The TCI codepoints may be TCI codepoints for PDSCH. For example, the network, via the first TRP 302 and/or the second TRP 304 may provide to the UE 306 one or more indications of which SSBs are associated with which TCI codepoints. The network may provide the indications within a TCI configuration communication (such as the TCI configuration communication 212 (FIG. 2)). For example, the network may provide one or more indications that indicate that the first SSB 308 is associated with a codepoint of the first TRS 312, that the second SSB 310 is associated with a codepoint of the second TRS 314, that the third SSB 320 is associated with the third TRS 324, and that the fourth SSB 322 is associated with the fourth TRS 326. As the UE 306 is aware that the first TRS 312 is associated with the first TRP 302, the UE 306 may determine that the first SSB 308 is associated with the first TRP 302 based on the indicated association between the first SSB 308 and the TCI codepoint of the first TRS 312. As the UE 306 is aware that the second TRS 314 is associated with the first TRP 302, the UE 306 may determine that the second SSB 310 is associated with the first TRP 302 based on the indicated association between the second SSB 310 and the TCI codepoint of the second TRS 314. As the UE 306 is aware that the third TRS 324 is associated with the second TRP 304, the UE 306 may determine that the third SSB 320 is associated with the second TRP 304 based on the indicated association between the third SSB 320 and the TCI codepoint of the third TRS 324. As the UE 306 is aware that the fourth TRS 326 is associated with the second TRP 304, the UE 306 may determine that the fourth SSB 322 is associated with the second TRP 304 based on the indicated association between the fourth SSB 322 and the TCI codepoint of the fourth TRS 326.

In the explicit configuration 2 of approach 1.4, the network may independently configure association between each of the SSBs and the corresponding TRPs. For example, the network may provide, via the first TRP 302 and/or the second TRP 304, an indication of associations between the SSBs and the TRPs to the UE 306. The indication of the associations may comprise a mapping (such as a bitmap) between the SSBs and the corresponding TRPs. In some embodiments, the network may provide the indication in a

MAC-CE and/or RRC communication. In the illustrated embodiment, the first TRP 302 and/or the second TRP 304 may provide one or more indications that the first SSB 308 is associated with the first TRP 302, the second SSB 310 is associated with the first TRP 302, the third SSB 320 is associated with the second TRP 304, and the fourth SSB 322 is associated with the second TRP 304. The UE 306 may determine the associations between the SSBs and the TRPs based on the indication. In particular, the UE 306 may determine that the first SSB 308 is received from the first TRP 302, the second SSB 310 is received from the first TRP 302, the third SSB 320 is received from the second TRP 304, and the fourth SSB 322 is received from the second TRP 304 based on the indication.

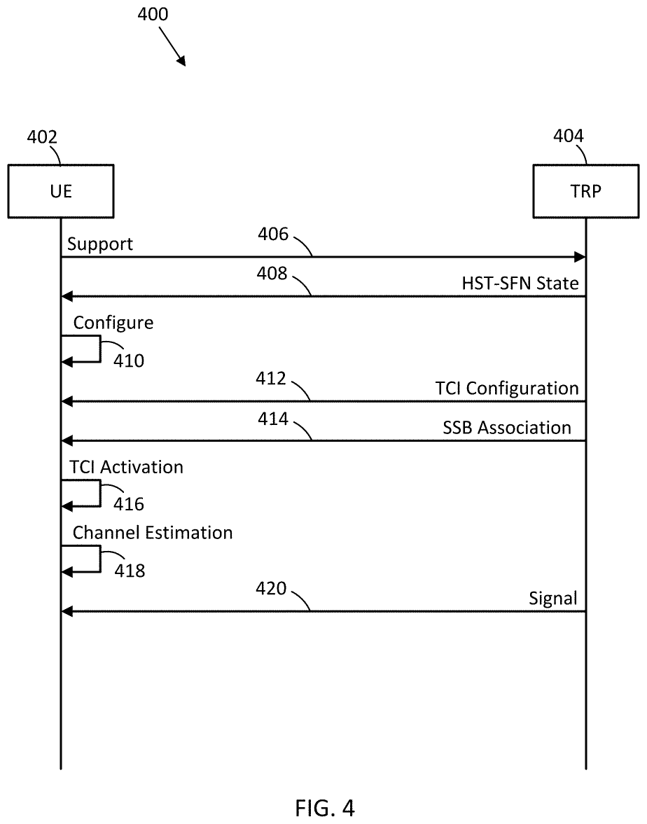

FIG. 4 illustrates an example signal flow 400 for approach 1.4 in accordance with some embodiments. In particular, the signal flow 400 illustrates signals that may be exchanged between a UE 402 and a TRP 404. It should be understood that the signals in the signal flow 400 may be transmitted in different orders than shown and/or concurrently. Additionally, the signal flow 400 may omit some signals (such as acknowledgement signals and/or failure signals) that may be transmitted in configuring approach 1.4. Further, one or more of the signals shown in the signal flow 400 may be omitted in some embodiments. The UE 402 may include one or more of the features of the UE 106 (FIG. 1). The TRP 404 may include one or more of the features of the first TRP 102 (FIG. 1) and/or the second TRP 104 (FIG. 1). In some embodiments, features of the signal flow 400 may be combined with features of the signal flow 200 (FIG. 2), such as the signal flow 400 including the features related to the configuration of the HSV-SFN states and/or the TCI states described in relation to the signal flow 200. Accordingly, approach 1.4 may include one or more of the features of approach 1.1, approach 1.2, and/or approach 1.3, such as the configuration of the HSV-SFN states and/or the TCI states.

The signal flow 400 may with the UE 402 transmitting a support indication 406 to the TRP 404 that indicates features supported and/or not supported by the UE 402. In some embodiments, the support indication 406 may comprise one or more UE capability reports that indicate the capabilities of the UE 402. The support indication 406 may indicate whether the UE supports HSV-SFN. For example, the support indication 406 may include a UE capability report that indicates whether the UE 402 supports HSV-SFN. Further, the support indication 406 may include an indication of whether the UE 402 supports HSV-SFN scheme 1 in some embodiments. In some embodiments, the UE 402 may provide the support indication 406 in response to a capability request provided by the TRP 404 to the UE 402. In other embodiments, the UE 402 may provide the support indication 406 upon joining the network (such as the UE 402 registering with the network and/or the UE 402 being powered on) and the network may store the information included in the support indication 406.

Based on the support indication 406, the network and/or the TRP 404 may determine whether the UE 402 supports HSV-SFN scheme 1. In some embodiments, the network and/or the TRP 404 may determine whether the UE 402 supports SSB association with TRPs, the implicit configuration of approach 1.4, the explicit configuration 1 of approach 1.4, the explicit configuration 2 of approach 1.4, or some combination thereof. The signal flow 400 may proceed with approach 1.4 based on the determination that the UE supports SSB association with TRPs in some embodiments.

The network and/or the TRP 404 may determine an HSV-SFN state configuration for the UE 402. In embodiments, where the support indication 406 is included, the network and/or the TRP 404 may determine an HSV-SFN state configuration based on the information within the support indication 406. The TRP 404 may provide an HSV-SFN state configuration communication 408 to the UE 402 that indicates a configuration for the UE 402. The HSV-SFN state configuration communication 408 may indicate that the UE 402 is to operate in HSV-SFN scheme 1 and/or single-TRP. The UE 402 may determine the HSV-SFN configuration for the UE 402 based on the HSV-SFN state configuration communication 408. In 410, the UE 402 may configure itself in accordance with the states determined from the HSV-SFN state configuration communication 408.

The network and/or the TRP 404 may further determine TCI configuration for the UE 402. In embodiments, where the support indication 406 is included, the network and/or the TRP 404 may determine TCI configuration for the UE 402 based on the information within the support indication 406. In the implicit configuration of approach 1.4, the network and/or the TRP 404 may configure the SSBs as the QCL sources of the corresponding TRSs. In the explicit configuration 1 of approach 1.4, the network and/or the TRP 404 may determine which SSBs are to be associated with which TCI codepoints. In some embodiments, the network and/or the TRP 404 may generate a TCI configuration communication 412 that indicates the TCI configuration for the UE 402. In the implicit configuration of approach 1.4, the TCI configuration communication 412 may include configuration information to configure the SSBs as the QCL sources of the corresponding TRSs. In the explicit configuration of approach 1.4, the TCI configuration communication 412 may include indication of associations to be made between SSBs and corresponding TCI codepoints, where the TCI codepoints may be TCI codepoints for PDSCH in some embodiments. The network and/or the TRP 404 may provide the TCI configuration communication 412 to the UE 402.

In the explicit configuration 2 of approach 1.4, the network and/or the TRP 404 may further generate a SSB association communication 414. The SSB association communication 414 may include an indication of associations between SSBs and corresponding TRPs. In some embodiments, the indication of the associations may include a mapping (such as a bitmap) between SSBs and corresponding TRPs. The indication of the associations may indicate which SSB is associated with which TRP. In some embodiments, the SSB association communication 414 may comprise a MAC-CE or a RRC communication. The TRP 404 may provide the SSB association communication 414 to the UE 402. In the implicit configuration of approach 1.4 and the explicit configuration 1 of approach 1.4, the SSB association communication 414 may be omitted.

The UE 402 may determine the configuration of TCI states for TCI codepoints based on the TCI configuration communication 412 and/or the SSB association communication 414. In some embodiments, the UE 402 may determine associations between SSBs and TRPs based on the TCI configuration communication 412 and/or the SSB association communication 414. In 416, the UE 402 may perform TCI activation, which may result in the TCI codepoints being activated in accordance with the determined configuration of the TCI states for the TCI codepoints.

In 418, the UE 402 may perform a channel estimation procedure. The channel estimation procedure may include performance of a coarse time and frequency tracking estimation based on the SSBs. For example, the UE 402 may estimate a coarse time and frequency for each of the TRPs based on the SSBs, where the UE 402 may determine which TRP from which each of the SSBs are received. The UE 402 may track the time and frequency for each of the SSBs to produce a coarse time and frequency estimation of the TRPs. In some embodiments, the channel estimation procedure may include performing fine time and frequency tracking estimation based on TRSs associated with the TRPs. The fine time and frequency tracking estimation may be more precise than the course time and frequency tracking estimation. In some embodiments, the UE 402 may be able to perform the coarse time and frequency tracking estimation at a greater frequency than the fine time and frequency tracking estimation, and/or may be able to perform the coarse time and frequency tracking estimation quicker than the fine time and frequency tracking estimation. The UE 402 may utilize the coarse time and frequency tracking estimation and/or the fine time and frequency tracking estimation to estimate Doppler shift of signals between the UE 402 and the TRP 404.

The UE 402 may further utilize the coarse time and frequency tracking estimation and/or the fine time and frequency tracking estimation in transmission and/or processing of signals between the UE 402 and the TRP 404. For example, the TRP 404 may provide a signal 420 to the UE 402. The UE 402 may utilize the coarse time and frequency tracking estimation and/or the fine time and frequency tracking estimation to process the signal 420. Further, the UE 402 may utilize the coarse time and frequency tracking estimation and/or the fine time and frequency tracking estimation in providing signals from the UE 402 to the TRP 404.

Approach 2: Design for HSV-SFN with Pre-Compensation

In approach 2, a network and UE may be configured with HSV-SFN with pre-compensation. In particular, the approaches described below associated with approach 2, the network may pre-compensate for Doppler shift. For example, the network may transmit signals with timing compensated for the Doppler shift, configure the UE with scheduling timing compensated for the Doppler shift, or some combination thereof. The network may determine the Doppler shifts between each TRP and a UE moving at high speeds.

Approach 2.1: HSV-SFN with pre-compensation can be supported for PDCCH. For example, the network and UE may support HSV-SFN with pre-compensation for PDCCH for communications between TRPs and the UE. For a particular CORESET in a particular CC, MAC-CE can be used to configure two TCI States. One TCI State has the QCL-TypeA properties, i.e., {average delay, delay spread, Doppler shift, Doppler spread}, and QCL-TypeD if applicable. The other TCI State has new QCL properties of {average delay, delay spread}, and QCL-TypeD if applicable. MAC-CE or RRC can indicate that for this TCI State, some QCL properties are dropped, e.g., {Doppler shift, Doppler spread}. For example, the network and/or TRP of the network may provide configuration information to the UE that indicates the two TCI states for configuration of corresponding CORESETs for the UE. The configuration information may indicate that the corresponding CORESETs are to be configured with a first TCI state and a second TCI state. The first TCI state may comprise QCL-TypeA properties, such as average delay, delay spread, Doppler shift, and Doppler spread. In some embodiments, the first TCI state may further comprise QCL-TypeD properties. The second TCI state may comprise QCL properties of average delay and delay spread. In some embodiments, the second TCI state may further comprise QCL-TypeD properties. In some embodiments, the network and/or TRP of the network may indicate that Doppler shift and Doppler spread are to be dropped for the second TCI state. The configuration may be provided via MAC-CE or RRC in embodiments.

Approach 2.2: When HSV-SFN with pre-compensation is supported for PDCCH, new RRC parameter can be introduced to configure the HSV-SFN with pre-compensation PDCCH operation. For example, a network and/or a TRP of the network may generate an RRC parameter that can be utilized to configure HSV-SFN with pre-compensation for PDCCH operation. When RRC configures HSV-SFN with pre-compensation PDCCH operation, if UE does not support mixed PDCCH monitoring mode, in the same BWP or CC, NW can only use MAC-CE to activate CORESET with two TCI States. If UE supports mixed PDCCH monitoring mode, in the same BWP or CC, NW can use MAC-CE to activate some CORESET with two TCI States, or activate some CORESET with single TCI State. For example, the UE may provide an indication to the network and/or TRP whether the UE supports mixed PDCCH monitoring mode. The mixed PDCCH monitoring mode may comprise a CORESET having TCI codepoints of the CORESET capable of being configured with a mix of two TCI states and a single TCI state. In instances where the UE indicates that mixed PDCCH monitoring mode is not supported by the UE, the network and/or the TRP may determine to activate CORESETs with a single TCI state. In instances where the UE indicates that mixed PDCCH monitoring mode is supported by the UE, the network and/or the TRP may determine to activate CORESETs with a single TCI state, two TCI states, or a mix of a single TCI state and two TCI states. The TRP may provide a TCI configuration communication to the UE that indicates configuration of the CORESETs for activation. In some embodiments, the TCI configuration communication may comprise a MAC-CE.

Approach 2.3: When HSV-SFN with pre-compensation is supported for PDSCH, PDSCH HSV-SFN with compensation is configured with both of the following: MAC-CE to activate PDSCH TCI codepoint with two TCI States. One TCI State has the QCL-TypeA properties, i.e., {average delay, delay spread, Doppler shift, Doppler spread}, and QCL-TypeD if applicable. The other TCI State has new QCL properties of {average delay, delay spread}, and QCL-TypeD if applicable. RRC parameter: RRC parameter could be (1) per BWP or (2) per CC. For example, the UE may provide the network and/or a TRP of the network with an indication whether the UE supports HSV-SFN with pre-compensation for PDSCH. When HSV-SFN with pre-compensation is supported by the UE for PDSCH, the network and/or TRP may utilize a MAC-CE to activate TCI codepoint and an RRC parameter that can configure the HSV-SFN state per BWP or per CC. The MAC-CE may configure the TCI codepoint for the PDSCH with two states. The first TCI state may include QCL-TypeA properties of average delay, delay spread, Doppler shift, and Doppler spread. In some embodiments, the first TCI state may further include QCL-TypeD properties. The second TCI state may include QCL properties of average delay and delay spread. In some embodiments, the second TCI state may further include QCL-TypeD properties.

Approach 2.4: When RRC parameter configures UE to operate in HSV-SFN with pre-compensation PDSCH operation, and, UE is not capable of dynamic switching of HSV-SFN with pre-compensation with other schemes. UE can only use MAC-CE to activate PDSCH TCI codepoint with two TCI States. For each activated TCI codepoint: One of the TCI States has to be configured with QCL-TypeA properties, and QCL-TypeD if applicable. The other TCI State has to be configured with new QCL properties of {average delay, delay spread}, and QCL-TypeD if applicable. For example, UE may indicate to the network and/or a TRP of the network whether the UE supports dynamic switching of HSV-SFN with pre-compensation with other schemes. When the network and/or the TRP configures the UE in HSV-SFN with pre-compensation for PDSCH operation, the network and/or the TRP may determine that the TCI codepoints for PDSCH are to be activated with the two TCI states. The network and/or the TRP may utilize an RRC parameter to configure the UE with HSV-SFN with pre-compensation for PDSCH. Further, the network and/or the TRP may utilize a MAC-CE to activate the TCI codepoint with two TCI states. The first TCI state may include QCL-TypeA properties of average delay, delay spread, Doppler shift, and Doppler spread. In some embodiments, the first TCI state may include QCL-TypeD properties. The second TCI state may comprise TCI properties of average delay and delay spread. In some embodiments, the second TCI state may further include QCL-TypeD properties.

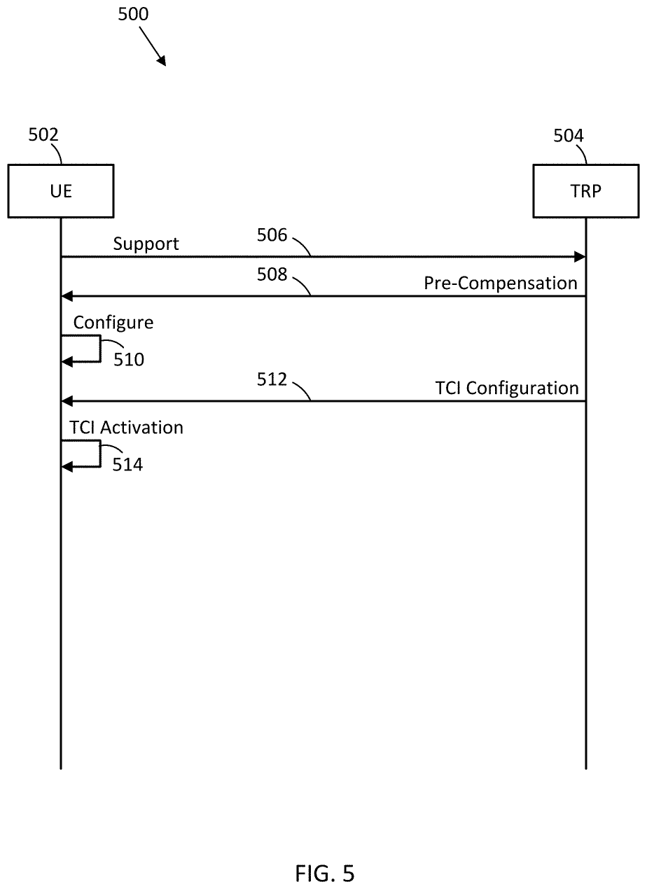

FIG. 5 illustrates an example signal flow 500 that can support approach 2.1, approach 2.2, approach 2.3, and/or approach 2.4 in accordance with some embodiments. In particular, the signal flow 500 illustrates signals that may be exchanged between a UE 502 and a TRP 504. It should be understood that the signals in the signal flow 500 may be transmitted in different orders than shown and/or concurrently. Additionally, the signal flow 500 may omit some signals (such as acknowledgement signals and/or failure signals) that may be transmitted in configuring approach 2.1, approach 2.2, approach 2.3, and/or approach 2.4. Further, one or more of the signals shown in the signal flow 500 may be omitted in some embodiments. The UE 502 may include one or more of the features of the UE 106 (FIG. 1). The TRP 504 may include one or more of the features of the first TRP 102 (FIG. 1) and/or the second TRP 104 (FIG. 1).

The signal flow 500 may initiate with the UE 502 transmitting a support indication 506 to the TRP 504 that indicates features supported and/or not supported by the UE 502. In some embodiments, the support indication 506 may comprise one or more UE capability reports that indicate the capabilities of the UE 502. The support indication 506 may indicate whether the UE 502 supports HSV-SFN with pre-compensation. In some embodiments, the support indication 506 may further indicate whether the UE supports mixed PDCCH monitoring mode and/or whether the UE supports dynamic switching of HSV-SFN with pre-compensation with other schemes. In some embodiments, the UE 502 may provide the support indication 506 in response to a capability request provided by the TRP 504 to the UE 502. In other embodiments, the UE 502 may provide the support indication 506 upon joining the network (such as the UE 502 registering with the network and/or the UE 502 being powered on) and the network may store the information included in the support indication 506.

The network and/or the TRP 504 may determine configuration for the UE 502 based on the information from the support indication 506. For example, the network and/or the TRP 504 may determine whether the UE 502 supports HSV-SFN with pre-compensation based on the support indication 506. For approach 2.2, the network and/or the TRP 504 may further determine whether the UE supports mixed PDCCH monitoring mode based on the support indication 506. For approach 2.4, the network and/or the TRP 504 may further determine whether the UE supports dynamic switching of HSV-SFN with pre-compensation with other schemes.

In approach 2.1, the network and/or the TRP 504 may determine that a CORESET for a particular CC is to be configured with two TCI states. The first TCI state may include QCL-TypeA properties of average delay, delay spread, Doppler shift, and Doppler spread. The first TCI state may further include QCL-TypeD properties in some embodiments. The second TCI state may include QCL properties of average delay and delay spread. In some embodiments, the second TCI state may further include QCL-TypeD properties. In approach 2.1, the network and/or the TRP 504 may generate a pre-compensation configuration communication 508 that indicates the determined configuration of the HSV-SFN with compensation for the PDCCH for the UE 502. In some embodiments, the pre-compensation configuration may comprise a MAC-CE or an RRC for the second TCI state that indicates that Doppler shift and Doppler spread are dropped. The TRP 504 may provide the pre-compensation configuration communication 508 to the UE 502.

In approach 2.2, the network and/or the TRP 504 may determine whether the UE supports mixed PDCCH monitoring mode. If the network and/or the TRP 504 determines that the UE does not support mixed PDCCH monitoring mode, the network and/or the TRP may determine that a CORESET corresponding to a BWP or a CC may be activated with two TCI states. If the network and/or the TRP 504 determines that the supports mixed PDCCH monitoring mode, the network and/or the TRP 504 may determine that some CORESETs corresponding to a BWP or a CC are to activated with two TCI states and some other CORESETs corresponding to the BWP or the CC are to be activated with a single TCI state. In approach 2.2, the network and/or the TRP 504 may generate a pre-compensation configuration communication 508 that indicates the determined configuration of the HSV-SFN with compensation for the PDCCH for the UE 502. The TRP 504 may provide the pre-compensation configuration communication 508 to the UE 502.

In approach 2.3, the network and/or the TRP 504 may determine to configure HSV-SFN with a MAC-CE and an RRC parameter. The RRC parameter may include that the HSV-SFN is configured on a per BWP or a per CC basis. The MAC-CE may determine to activate the TCI codepoint for PDSCH with two TCI states. The first TCI state may include QCL-TypeA properties of average delay, delay spread, Doppler shift, and Doppler spread. The first TCI state may further include QCL-TypeD properties in some embodiments. The second TCI state may include QCL properties of average delay and delay spread. In some embodiments, the second TCI state may further include QCL-TypeD properties. In approach 2.3, the network and/or the TRP 504 may generate a pre-compensation configuration communication 508 that indicates the determined configuration of the HSV-SFN with compensation for the PDSCH for the UE 502. The pre-compensation configuration communication 508 may comprise the RRC parameter in some embodiments. The TRP 504 may provide the pre-compensation configuration communication 508 to the UE 502.

In approach 2.4, the network and/or the TRP 504 may determine that the UE does not support dynamic switching of HSV-SFN with pre-compensation with other schemes. Based on the determination that the UE does not support dynamic switching of HSV-SFN with pre-compensation with other schemes, the network and/or the TRP 504 may determine to activate TCI codepoints for PDSCH with two TCI states. For each activated TCI codepoint, the network and/or the TRP 504 may determine to activate the TCI codepoint with two TCI states. The first TCI state may include QCL-TypeA properties of average delay, delay spread, Doppler shift, and Doppler spread. The first TCI state may further include QCL-TypeD properties in some embodiments. The second TCI state may include QCL properties of average delay and delay spread. In some embodiments, the second TCI state may further include QCL-TypeD properties. In approach 2.4, the network and/or the TRP 504 may generate a pre-compensation configuration communication 508 that indicates the determined configuration of the HSV-SFN with compensation for the PDSCH for the UE 502. The pre-compensation configuration communication 508 may comprise the RRC parameter in some embodiments. The TRP 504 may provide the pre-compensation configuration communication 508 to the UE 502.

The UE 502 may determine the HSV-SFN with pre-compensation configuration for the UE 502 based on the pre-compensation configuration communication 508 received from the TRP 504. In 510, the UE 502 may configure the UE 502 with the HSV-SFN with pre-compensation configuration determined based on the pre-compensation configuration communication 508. For example, in approach 2.1 and/or approach 2.2 the UE 502 may configure the CORESETs in accordance with the configuration determined based on the pre-compensation configuration communication 508. In approach 2.3 and/or approach 2.4, the UE 502 may configure the BWPs or the CCs in accordance with the configuration determined based on the pre-compensation configuration communication 508.

The network and/or the TRP 504 may further generate a TCI configuration communication 512 that indicates the configuration determined for the TCI codepoints, the configuration being determined by the network and/or the TRP 504. In some embodiments, the TCI configuration communication 512 may comprise a MAC-CE. For approach 2.1, the TCI configuration communication 512 may indicate that the TCI codepoints for the PDCCH are to be activated with the two TCI states, such as the first TCI state and the second TCI state described above. For approach 2.2, the TCI configuration communication 512 may indicate that the CORESET for the PDCCH are to be activated with two TCI states in the same BWP or CC when it is determined that the UE 502 does not support mixed PDCCH monitoring mode. When it is determined that the UE supports mixed PDCCH monitoring mode for approach 2.2, the TCI configuration communication 512 may indicate that some CORESETs in the BWP or CC are to be activated with two TCI states and some CORESETs in the same BWP or CC are to be activated with one TCI state. For approach 2.3, the TCI configuration communication 512 may indicate that TCI codepoints for PDSCH are to be activated with two states, such as the first TCI state and the second TCI state described above. For approach 2.4, the TCI configuration communication 512 may indicate that TCI codepoints for PDSCH are to be activated with two states (such as the first TCI state and the second TCI state described above) based on the UE not supporting dynamic switching of HSV-SFN with pre-compensation with other schemes.

The UE 502 may determine activation configuration for the UE 502 based on the TCI configuration communication 512. In 514, the UE 502 may perform TCI activation to activate TCI codepoints in accordance with the determined activation configuration.

Approach 2.5: For time and frequency tracking, NW explicitly or implicitly configure the association of SSB with TRP. For example, the network and/or a TRP of the network may configure or provide configuration information to the UE for the UE to be able to associate SSBs with the TRPs that provide the SSBs. Implicit configuration: NW configures SSB to be the QCL source of TRS, which implicitly indicates the association between SSB and TRP since TRS is used for QCL source of PDSCH/DMRS. If TRS itself is configured with reduced set of QCL properties, the associated SSB is also configured with the same reduced set of QCL properties. For example, the network and/or the TRP may provide configuration information to the UE that causes the UE to configure a SSB as a QCL source of a TRS, which may be part of the TRS configuration. The UE may be aware of which TRS is associated with which TRP, which may be derived from QCL TCI state configuration. The UE may determine which SSB is associated with which TRP based on the SSB being configured as the QCL source of the TRS and the known association of the TRS with the TRP. Accordingly, the network and/or the TRP may implicitly configure the association of SSBs with TRPs in the implicit configuration of approach 2.5. If a TRS has a reduced set of QCL properties (such as QCL properties of average delay and delay spread), the SSBs associated with the TRS may be configured with the same reduced set of QCL properties. If a SSB is not configured as QCL source of TRS used for PDSCH/DMRS QCL indication, UE cannot assume the associate of SSB with any TRP. For example, the UE may be unable to determine the source TRP of a SSB in instances where the SSB is not configured as the QCL source of the TRS.

Explicit configuration 1: When NW uses the MAC-CE to activate the TCI codepoint for PDSCH, NW configures the association of each TCI codepoint with different SSBs. For example, the network and/or a TRP of the network may provide an association between a TCI codepoint and an SSB. The network and/or the TRP may provide the association when providing activation for the TCI codepoint, such as including an indication of the association in the TCI configuration communication 212 (FIG. 2). In some embodiments, the indication of the association may include a mapping between TCI codepoints and SSBs. In some embodiments, the indication of the association may comprise a MAC-CE. The TCI codepoint may include a TRS, where the UE may be aware of with which TRP each TRS is associated. The UE may determine which SSB corresponds to which TRP based on the association between the TCI codepoint and the SSB, and the relationship between each TRS and each TRP. Accordingly, the network and/or the TRP may explicitly configure the association of SSBs with TRPs in the explicit configuration 1 of approach 2.5. For the SSBs not configured with the association, UE cannot assume the association of SSB with any TRP. For example, the UE may be unable to determine the source TRP of a SSB in instances where the SSB is not configured as the QCL source of the TRS.

Explicit configuration 2: NW independently configures for each SSB whether it is from first TRP or second TRP or none. Which QCL properties it has among {average delay, delay spread, Doppler shift, Doppler spread}, or {average delay, delay spread}. For example, the network and/or a TRP of the network may provide a separate communication to a UE that indicates which SSBs are associated with which TRPs. The separate communication may comprise a MAC-CE or an RRC. The MAC-CE and the RRC for indication of the association may be separate from other MAC-CEs and/or RRCs utilized for configuration of the HSV-SFN state and/or the TCI configuration. In some embodiments, the indication may comprise a mapping (such as a bitmap) that indicates which SSB is associated with which TRP. In some embodiments, the separate communication may further indicate which QCL properties each of the SSB comprises. In particular, the separate communication may indicate whether each SSB comprises QCL properties of average delay, delay spread, Doppler shift, and Doppler spread, or comprises QCL properties of average delay and delay spread.

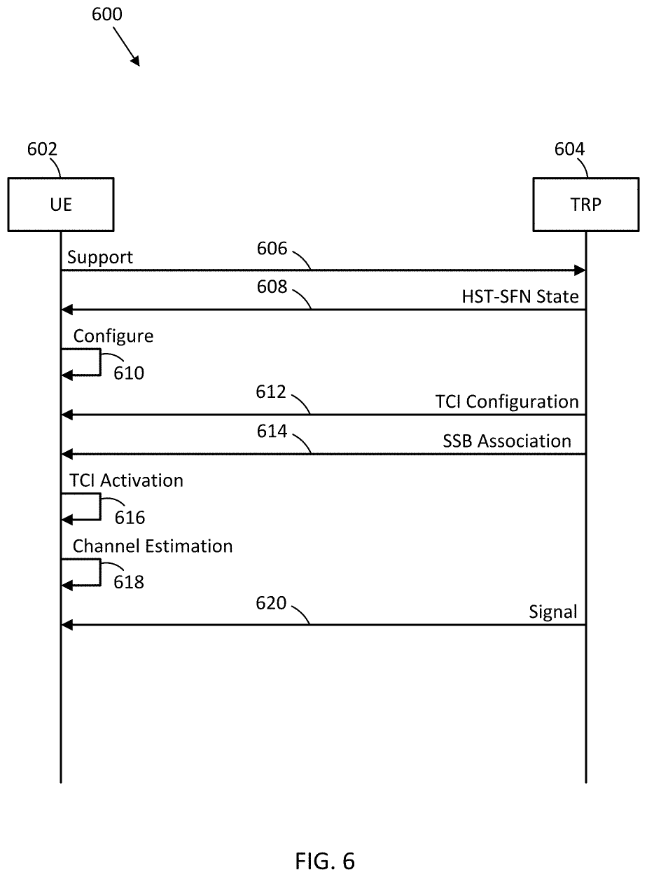

FIG. 6 illustrates an example signal flow 600 for approach 2.5 in accordance with some embodiments. In particular, the signal flow 600 illustrates signals that may be exchanged between a UE 602 and a TRP 604. It should be understood that the signals in the signal flow 600 may be transmitted in different orders than shown and/or concurrently. Additionally, the signal flow 600 may omit some signals (such as acknowledgement signals and/or failure signals) that may be transmitted in configuring approach 2.5. Further, one or more of the signals shown in the signal flow 600 may be omitted in some embodiments. The UE 602 may include one or more of the features of the UE 106 (FIG. 1). The TRP 604 may include one or more of the features of the first TRP 102 (FIG. 1) and/or the second TRP 104 (FIG. 1). In some embodiments, features of the signal flow 600 may be combined with features of the signal flow 500 (FIG. 6), such as the signal flow 600 including the features related to the configuration of the HSV-SFN states and/or the TCI states described in relation to the signal flow 500. Accordingly, approach 2.5 may include one or more of the features of approach 2.1, approach 2.2, approach 2.3, and/or approach 2.4, such as the configuration of the HSV-SFN states and/or the TCI states.

The signal flow 600 may with the UE 602 transmitting a support indication 606 to the TRP 604 that indicates features supported and/or not supported by the UE 602. In some embodiments, the support indication 606 may comprise one or more UE capability reports that indicate the capabilities of the UE 602. The support indication 406 may indicate whether the UE supports HSV-SFN with pre-compensation. For example, the support indication 606 may include a UE capability report that indicates whether the UE 602 supports HSV-SFN with pre-compensation. Further, the support indication 606 may include an indication of whether the UE 602 supports SSB association with TRPs in some embodiments. In some embodiments, the UE 602 may provide the support indication 606 in response to a capability request provided by the TRP 604 to the UE 602. In other embodiments, the UE 602 may provide the support indication 606 upon joining the network (such as the UE 602 registering with the network and/or the UE 602 being powered on) and the network may store the information included in the support indication 606.

Based on the support indication 606, the network and/or the TRP 604 may determine whether the UE 602 supports HSV-SFN with pre-compensation. In some embodiments, the network and/or the TRP 604 may determine whether the UE 602 supports SSB association with TRPs, the implicit configuration of approach 2.5, the explicit configuration 1 of approach 2.5, the explicit configuration 2 of approach 2.5, or some combination thereof. The signal flow 600 may proceed with approach 2.5 based on the determination that the UE supports SSB association with TRPs in some embodiments.

The network and/or the TRP 604 may determine an HSV-SFN state configuration for the UE 602. In embodiments, where the support indication 606 is included, the network and/or the TRP 604 may determine an HSV-SFN state configuration based on the information within the support indication 606. The TRP 604 may provide an HSV-SFN state configuration communication 608 to the UE 602 that indicates a configuration for the UE 602. The HSV-SFN state configuration communication 608 may indicate that the UE 602 is to operate in HSV-SFN with pre-compensation and/or single-TRP. The UE 602 may determine the HSV-SFN configuration for the UE 602 based on the HSV-SFN state configuration communication 608. In 610, the UE 602 may configure itself in accordance with the states determined from the HSV-SFN state configuration communication 408.

The network and/or the TRP 604 may further determine TCI configuration for the UE 602. In embodiments, where the support indication 606 is included, the network and/or the TRP 604 may determine TCI configuration for the UE 602 based on the information within the support indication 606. In the implicit configuration of approach 2.5, the network and/or the TRP 404 may configure the SSBs as the QCL sources of the corresponding TRSs. In the explicit configuration 1 of approach 2.5, the network and/or the TRP 604 may determine which SSBs are to be associated with which TCI codepoints. In some embodiments, the network and/or the TRP 604 may generate a TCI configuration communication 612 that indicates the TCI configuration for the UE 602. In the implicit configuration of approach 2.5, the TCI configuration communication 612 may include configuration information to configure the SSBs as the QCL sources of the corresponding TRSs. In the explicit configuration of approach 2.5, the TCI configuration communication 612 may include indication of associations to be made between SSBs and corresponding TCI codepoints, where the TCI codepoints may be TCI codepoints for PDSCH in some embodiments. The network and/or the TRP 604 may provide the TCI configuration communication 612 to the UE 602.

In the explicit configuration 2 of approach 2.5, the network and/or the TRP 604 may further generate a SSB association communication 614. The SSB association communication 614 may include an indication of associations between SSBs and corresponding TRPs. In some embodiments, the indication of the associations may include a mapping (such as a bitmap) between SSBs and corresponding TRPs. The indication of the associations may indicate which SSB is associated with which TRP. In some embodiments, the SSB association may include indications of which SSBs are to be configured with QCL properties of average delay, delay spread, Doppler shift, and Doppler spread, and which SSBs are to be configured with QCL properties of average delay and delay spread. In some embodiments, the SSB association communication 614 may comprise a MAC-CE or a RRC communication. The TRP 604 may provide the SSB association communication 614 to the UE 602. In the implicit configuration of approach 2.5 and the explicit configuration 1 of approach 2.5, the SSB association communication 614 may be omitted.

The UE 602 may determine the configuration of TCI states for TCI codepoints based on the TCI configuration communication 612 and/or the SSB association communication 614. In some embodiments, the UE 602 may determine associations between SSBs and TRPs based on the TCI configuration communication 612 and/or the SSB association communication 614. In 616, the UE 602 may perform TCI activation, which may result in the TCI codepoints being activated in accordance with the determined configuration of the TCI states for the TCI codepoints.

In 618, the UE 602 may perform a channel estimation procedure. The channel estimation procedure may include performance of a coarse time and frequency tracking estimation based on the SSBs. For example, the UE 602 may estimate a coarse time and frequency for each of the TRPs based on the SSBs, where the UE 602 may determine which TRP from which each of the SSBs are received. The UE 602 may track the time and frequency for each of the SSBs to produce a coarse time and frequency estimation of the TRPs. In some embodiments, the channel estimation procedure may include performing fine time and frequency tracking estimation based on TRSs associated with the TRPs. The fine time and frequency tracking estimation may be more precise than the course time and frequency tracking estimation. In some embodiments, the UE 602 may be able to perform the coarse time and frequency tracking estimation at a greater frequency than the fine time and frequency tracking estimation, and/or may be able to perform the coarse time and frequency tracking estimation quicker than the fine time and frequency tracking estimation. The UE 602 may utilize the coarse time and frequency tracking estimation and/or the fine time and frequency tracking estimation to estimate Doppler shift of signals between the UE 602 and the TRP 604.

The UE 602 may further utilize the coarse time and frequency tracking estimation and/or the fine time and frequency tracking estimation in transmission and/or processing of signals between the UE 602 and the TRP 604. For example, the TRP 604 may provide a signal 620 to the UE 402. The UE 602 may utilize the coarse time and frequency tracking estimation and/or the fine time and frequency tracking estimation to process the signal 620. Further, the UE 602 may utilize the coarse time and frequency tracking estimation and/or the fine time and frequency tracking estimation in providing signals from the UE 602 to the TRP 604.

### Approach 3: Group Based TCI Update.

Approach 3.1: Support NW to update the TCI of PDSCH for multiple CCs of a UE with the same MAC-CE. For example, the network may utilize a single MAC-CE to update the TCI state of TCI codepoints of PDSCH for multiple CCs of a UE. Up to 2 CC lists can be configured by RRC. For example, the network may generate up to 2 CC lists. Each CC list may include one or more CCs. When updating the TCI state of TCI codepoints, the network may indicate a CC list, where the UE may update the TCI codepoints for the CCs included in the indicated CC list. The CC lists should be orthogonal. One CC cannot belong to multiple CCs MAC-CE to activate/deactivate TCI codepoint for UE-specific PDSCH. For example, each CC may belong to at most one CC list for using the single MAC-CE to activate/deactivate TCI codepoints.

When MAC-CE is used to activate up to a list of TCI codepoints for PDSCH, the same list of TCI codepoints is also updated for the PDSCH in the other CCs in the same CC list as the CC indicated by the MAC-CE. For example, the UE may maintain the CC lists. In response to receiving an indication to activate or deactivate a TCI codepoint or TCI codepoints for a first CC of the PDSCH, the UE may update the other CCs in the CC list that includes the first CC with the same updates as made to the first CC. In the same CC list, the scenario that some CCs are configured with HSV-SFN scheme and some CCs are configured without HSV-SFN scheme. Option 1: NW has to configure the same HSV-SFN for all the CCs in the same CC list. Option 2: UE activates only the first TCI State in the TCI codepoint if the corresponding CC does not support HSV-SFN scheme. For example, in instances where some of the CCs in a CC list are configured with an HSV-SFN scheme and some CCs in the same CC list are configured without an HSV-SFN scheme, then the network may configure all the CCs in the same CC list with the same HSV-SFN configuration, or the network may cause the UE to activate the first TCI state in the TCI codepoints for the corresponding CC if the CC does not support HSV-SFN scheme.

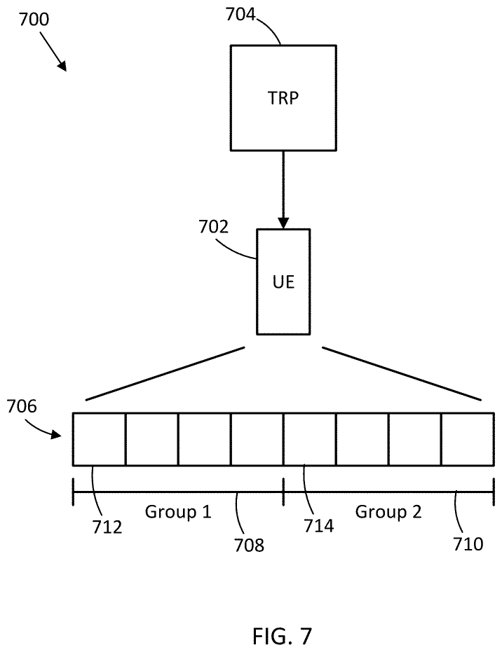

FIG. 7 illustrates an example network arrangement 700 showing the configuration of approach 3.1 in accordance with some embodiments. In particular, the network arrangement 700 shows a conceptual arrangement for approach 3.1 in accordance with some embodiments. The network arrangement 700 may include a UE 702 and a TRP 704. The UE 702 may include one or more of the features of the UE 106 (FIG. 1). The TRP 704 may include one or more of the features of the first TRP 102 (FIG. 1) and/or the second TRP 104 (FIG. 1).

The network arrangement 700 shows a plurality of CCs 706 of the UE 702. The plurality of CCs 706 may be CCs for the PDSCH. The plurality of CCs 706 are shown separated into a first group 708 and a second group 710. The first group 708 may include a first portion of the plurality of CCs 706 that correspond to a first CC list of approach 3.1. The second group 710 may include a second portion of the plurality of CCs 706 that correspond to a second list of approach 3.1.

The TRP 704 may provide a TCI update communication (such as the switch TCI communication 220 (FIG. 2)) to the UE 702 that indicates that TCI codepoints for one or more of the CCs within the plurality of CCs 706. Based on the TCI update communication, the UE 702 may determine whether the CCs to be updated are included in the first group 708 corresponding to the first CC list, the second group 710 corresponding to the second CC list, or some combination thereof. For example, the UE 702 may determine that some of the CCs to be updated are in the first group 708 and some other of the CCs to be updated are in the second group 710. The UE 702 may determine that the other CCs in the CC list with a CC to be updated are to be updated with the same HSV-SFN as the CC to be updated. For example, the UE 702 may determine that a first CC 712 within the first group 708 is to be updated based on the TCI update communication, and may update all the CCs within the first group 708 with the same HSV-SFN as requested for the first CC 712 in some instances. In some instances, the UE 702 may determine that a second CC 714 within the second group 710 is to be updated based on the TCI update communication, and may update all the CCs within the second group 710 with the same HSV-SFN as requested for the second CC 714. In instances where a CC determined to be updated does not support an HSV-SFN scheme, the UE may configure the CC with the first TCI state in some embodiments.

Approach 3.2: To support NW to update the TCI of PDCCH and/or PDSCH for multiple UEs with the same MAC-CE, UEs in the same group is configured with the same radio network temporary identifier (RNTI), e.g., high speed vehicle-radio network temporary identifier (HSV-RNTI), which is used to scramble the cyclic redundancy check (CRC) of the downlink control information (DCI). For example, the network may configure multiple UEs with a single HSV-RNTI. Accordingly, a first group of UEs may be configured with a first HSV-RNTI, a second group of UEs may be configured with a second HSV-RNTI, or so forth. To update a TCI configuration of a TCI codepoint of PDCCH and/or PDSCH, the network (via a TRP) may transmit a MAC-CE requesting update of the TCI configuration that includes an HSV-RNTI. Each of the UEs configured with the HSV-RNTI may update based on the MAC-CE requesting update of the TCI configuration. Accordingly, since more than one UE may be configured with the same HSV-RNTI, multiple UEs may update based on the single MAC-CE. Approach 3.2 may be beneficial when multiple UEs are traveling at roughly the same speed and in the same direction, such as when there are multiple UEs located within a vehicle.

Based on the common RNTI configuration, there are two approaches within approach 3.2: Approach 1: Relying on the regular downlink (DL) DCI, e.g., DCI format 1_1 or DCI format 1_2. All the UE in the same group configured with the same HSV-RNTI can decode the DCI, and then, decode the scheduled PDSCH. In the PDSCH, all UE can extract the MAC-CE. For example, the network and the UEs may utilize DCI format 1_1 or DCI format 1_2 to translate TCI configurations. All the UEs configured with the same HSV-RNTI may decode a scheduled PDSCH and extract a MAC-CE that requests update of a TCI configuration. Based on the extraction of the MAC-CE all the UEs may update in accordance with the TCI configuration of the MAC-CE. Approach 2: Relying on the special DCI, e.g., DCI format 2_7. All the UEs in the same group configured with the same HSV-RNTI can decode the DCI. DCI is divided into different blocks, and each UE is pre-configured with one block. UE will read the corresponding block which contains the common configuration among all the UEs configured with the same block. For example, each UE configured with a block of a special DCI. The special DCI may be divided into different blocks, where each special DCI communication can be divided into different blocks. The UEs may use the HSV-RNTI to decode a DCI communication. The UEs may then use the corresponding configured block to determine a block of the DCI to be utilized. The corresponding block of the DCI may indicate the TCI configuration for the UE. Accordingly, a UE may determine a TCI configuration for the UE based on the corresponding block of the DCI,

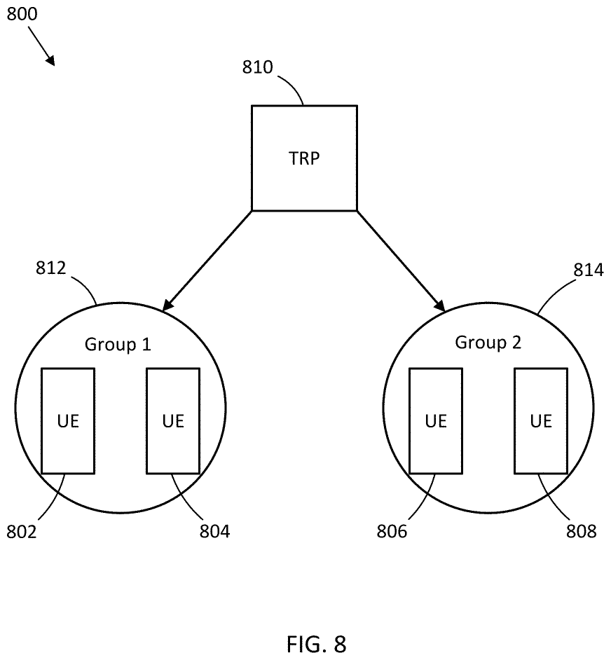

FIG. 8 illustrates an example network arrangement 800 showing the configuration of approach 3.2 in accordance with some embodiments. In particular, the network arrangement 800 shows a conceptual arrangement for approach 3.2 in accordance with some embodiments. The network arrangement 800 may include one or more UEs. For example, the illustrated network arrangement 800 includes a first UE 802, a second UE 804, a third UE 806, and a fourth UE 808. The first UE 802, the second UE 804, the third UE 806, and the fourth UE 808 each may include one or more of the features of the UE 106 (FIG. 1). The network arrangement 800 may include a TRP 810. The TRP 810 may include one or more of the features of the first TRP 102 (FIG. 1) and/or the second TRP 104 (FIG. 1).

In accordance with approach 3.2, the network, via the TRP 810, may configure one or more UEs with a same HSV-RNTI. For example, the first UE 802 and the second UE 804 may be configured by the network with a first HSV-RNTI in the illustrated embodiment, which may cause the first UE 802 and the second UE 804 to be included in a first group 812 having the first HSV-RNTI. Further, the third UE 806 may be configured by the network with a second HSV-RNTI in the illustrated embodiment, which may cause the third UE 806 and the fourth UE 808 to be included in a second group 814 having the second HSV-RNTI.

When the TRP 810 transmits a TCI configuration update communication (such as the switch TCI communication 220 (FIG. 2)) with an HSV-RNTI, the UEs within the corresponding to the HSV-RNTI may determine that the TCI configuration for the UE is to be updated. For example, if the TRP 810 transmits a TCI configuration update communication with the first HSV-RNTI corresponding to the first group 812, the first UE 802 and the second UE 804 within the first group 812 may determine that their TCI configurations are to be updated based on the TCI configuration update communication. The TCI configuration update communication may include a DCI that indicates the TCI configuration to which the UEs corresponding to the HSV-RNTI are to update.

In embodiments where the special DCI is utilized and the UEs are configured with a corresponding block of the special DCI, the UEs may look to the configured block of the special DCI for the TCI configuration. For example, the first UE 802 may be configured with a first block of the special DCI and the second UE 804 may be configured with a second block of the special DCI. When the TRP 810 transmits the TCI configuration update communication with the first HSV-RNTI corresponding to the first group 812, the first UE 802 may decode the special DCI and utilize the first block of the special DCI to determine the TCI configuration to which the first UE 802 is to update. Further, the second UE 804 may decode the special DCI and utilize the second block of the special DCI to determine the TCI configuration to which the second UE 804 is to update. The UEs may then update with the TCI configurations determined from the TCI configuration update communication.

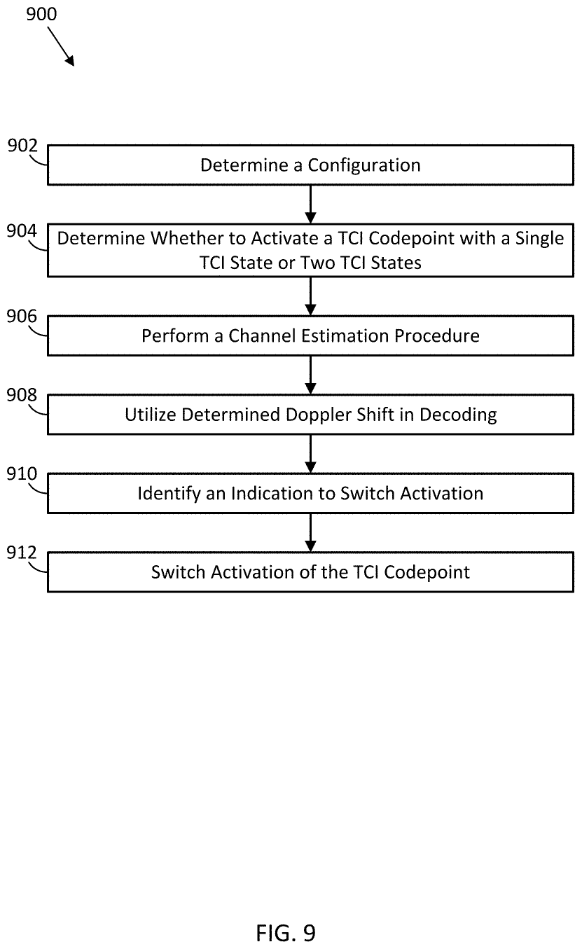

FIG. 9 illustrates an example procedure 900 in accordance with some embodiments. The procedure 900 may comprise a procedure for determining Doppler shift with any of the approaches described herein. The procedure 900 may be performed by a UE, where the UE may include one or more of the features of the UE 1400 (FIG. 14). It should be understood that the elements of the procedure 900 may be performed in a different order than shown and/or one or more of the elements may be performed concurrently. Further, one or more of the elements may be omitted in embodiments.

The procedure 900 may include determining a configuration in 902. In particular, the UE may determine a configuration per-BWP or per-CC. The configuration may be determined based on a RRC communication (such as the HSV-SFN state configuration communication 208 (FIG. 2), the HSV-SFN state configuration communication 408 (FIG. 4), and/or the pre-compensation configuration communication 508 (FIG. 5)) received from a TRP. The configuration may be to configure the UE to operate according to an HSV-SFN scheme 1 (such as the HSV-SFN scheme 1 described throughout this disclosure) within a BWP or a CC.

In some embodiments, the configuration may be determined per-CC, where the configuration is to configure the UE to operate according to the HSV-SFN scheme 1 within all BWPs of a CC. In some other embodiments, the configuration may be determined per-BWP, where the configuration is to configure the UE to operate according to the HSV-SFN scheme 1 within a first BWP of a CC and configure the UE to operate according to a single-TRP scheme within a second BWP of the CC.

The procedure 900 may further include determining whether to activate a TCI codepoint with a single TCI state or two TCI states in 904. The determination of whether to activate the TCI codepoint with a single TCI state or two TCI states (such as the single TCI state or the two TCI states described throughout this disclosure) may be determined based on a MAC-CE received from the TRP.

The procedure 900 may further include performing a channel estimation procedure in 906. In particular, the UE may perform a channel estimation procedure (such as the channel estimation procedures described throughout this disclosure) to determine a Doppler shift based on the TCI codepoint.

The procedure 900 may further include utilizing the determined Doppler shift in decoding in 908. In particular, the UE may utilize the determined Doppler shift determined in 906 in decoding at least one signal received by the UE. The at least one signal may be received via a PDSCH of the BWP or the CC.

The procedure 900 may further include identifying an indication to switch activation in 910. In particular, the UE may identify an indication in a second MAC-CE or DCI to switch activation of the TCI codepoint to the single TCI state or the two TCI states.

The procedure 900 may further include switching activation of the TCI codepoint in 912. In particular, the UE may switch activation of the TCI codepoint based on the indication. In some embodiments, switching activation may including switching from a first BWP to a second BWP.

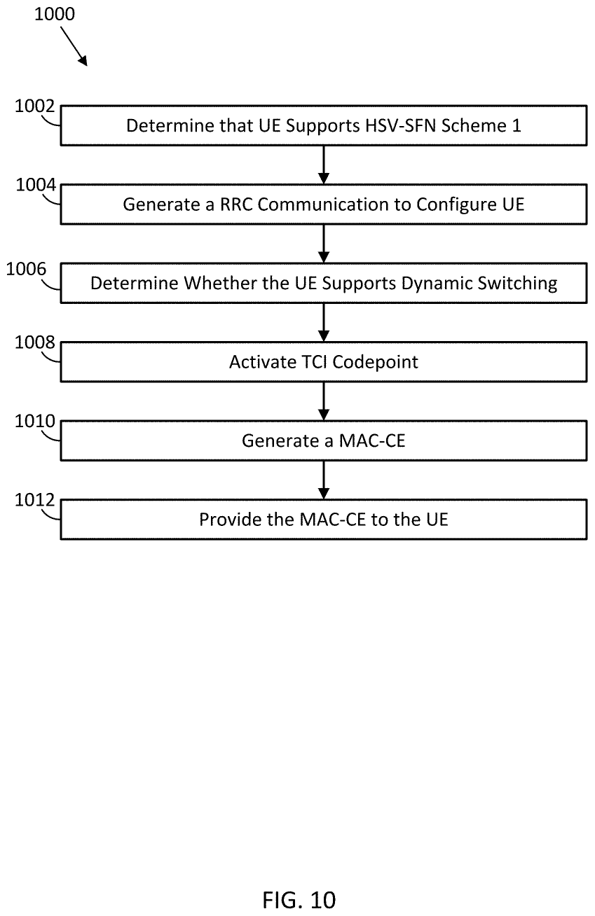

FIG. 10 illustrates an example procedure 1000 in accordance with some embodiments. The procedure 1000 may comprise a procedure for configuring with HSV-SFN in accordance with any of the approaches described herein. The procedure 1000 may be performed by a base station, where the base station may include one or more of the features of the gNB 1500 (FIG. 15). It should be understood that the elements of the procedure 1000 may be performed in a different order than shown and/or one or more of the elements may be performed concurrently. Further, one or more of the elements may be omitted in embodiments.

The procedure 1000 may include determining that a UE supports HSV-SFN scheme 1 in 1002. The UE may determine whether the UE supports HSV-SFN scheme 1 based on an indication received from the UE.

The procedure 1000 may further include generating a RRC communication to configure the UE in 1004. In particular, the base station may generate a RRC communication to configure a UE to operate according to HSV-SFN scheme 1 within a BWP or a CC. In some embodiments, the base station may generate the RRC based on the indication received in 1002.

The procedure 1000 may further include determining whether the UE supports dynamic switching in 1006. In particular, the base station may determine whether the UE supports dynamic switching between HSV-SFN scheme 1 and single-TRP scheme.

The procedure 1000 may further include activating TCI codepoint in 1008. In particular, the base station may activate TCI codepoint with a single TCI state or two TCI states based on determination of whether the UE supports dynamic switching between HSV-SFN scheme 1 and single-TRP scheme.

In some instances, the base station may determine that the UE does not support dynamic switching. In these instances, the base station may activate the TCI codepoint with two TCI states.

The procedure 1000 may further include generating a MAC-CE in 1010. In particular, the base station may generate a MAC-CE that indicates whether the TCI codepoint is to be activated with the single TCI state or the two TCI states. In some embodiments, the MAC-CE may indicate a particular CC for which the TCI codepoint is to be activated. In other embodiments, the MAC-CE may indicate a particular BWP of a CC for which the TCI codepoint is to be activated.

The procedure 1000 may further include providing the MAC-CE to the UE. In particular, the base station may provide the MAC-CE to the UE to configure the UE with the TCI codepoint.

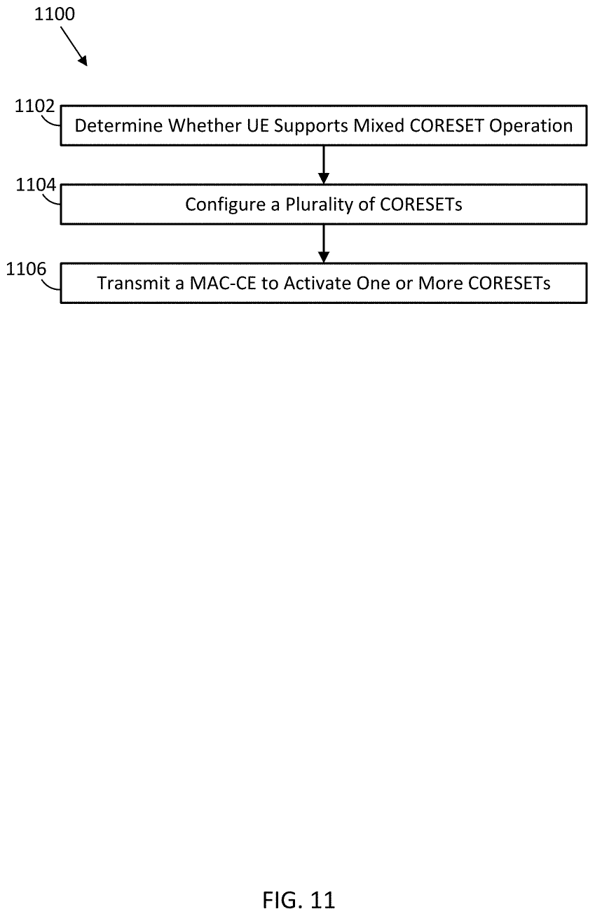

FIG. 11 illustrates an example procedure 1100 in accordance with some embodiments. The procedure 1100 may comprise a procedure for configuring with HSV-SFN in accordance with any of the approaches described herein. The procedure 1100 may be performed by a base station, where the base station may include one or more of the features of the gNB 1500 (FIG. 15). It should be understood that the elements of the procedure 1100 may be performed in a different order than shown and/or one or more of the elements may be performed concurrently. Further, one or more of the elements may be omitted in embodiments.

The procedure 1100 may include determining whether UE supports mixed CORESET operation in 1102. In particular, the base station may determine whether a UE supports mixed CORESET operation for HSV-SFN. Determining whether the UE supports mixed CORESET operation may include receiving a UE capability report that indicates the UE supports HSV-SFN, or receiving a UE capability report that indicates the UE supports the mixed CORESET operation. In some embodiments, the UE capability report may indicate that the UE supports HSV-SFN for a PDCCH.

The procedure 1100 may include configuring a plurality of CORESETs in 1104. In particular, the base station may configure a plurality of CORESETS of an active BWP based on whether the UE supports mixed CORESET operation for HSV-SFN.

The procedure 1100 may further include transmitting a MAC-CE to activate one or more CORESETs in 1106. In particular, the base station may transmit a MAC-CE to activate one or more CORESETs of the active BWP with a number of TCI states, the number of TCI states being one or two.

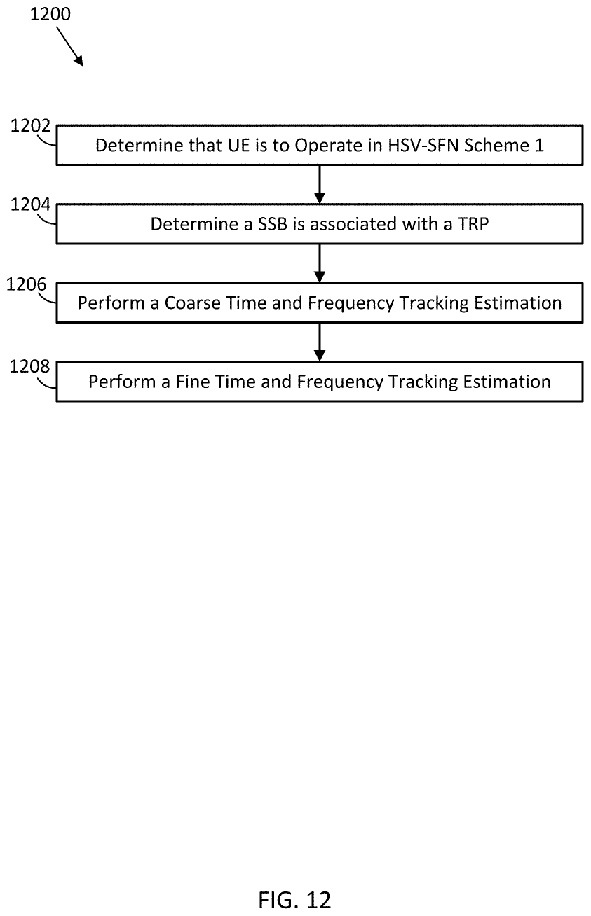

FIG. 12 illustrates an example procedure 1200 in accordance with some embodiments. The procedure 1200 may comprise a procedure for performing time and frequency tracking estimation in accordance with any of the approaches described herein. The procedure 1200 may be performed by a base station, where the base station may include one or more of the features of the UE 1400 (FIG. 14). It should be understood that the elements of the procedure 1200 may be performed in a different order than shown and/or one or more of the elements may be performed concurrently. Further, one or more of the elements may be omitted in embodiments.

The procedure 1200 may include determining that the UE is to operate in HSV-SFN scheme 1 in 1202. For example, the UE may determine that the UE is to operate in the HSV-SFN scheme 1 as described throughout this disclosure.

The procedure 1200 may include determining a SSB is associated with a TRP in 1204. In some embodiments, determining the SSB is associated with the TRP includes determining that the SSB is configured as a QCL source of a TRS. In some other embodiments, determine the SSB is associated with the TRP includes determining the SSB is associated with the TRP based on a MAC-CE received by the UE. Further, determining the

SSB is associated with the TRP includes determining the SSB is associated with the TRP based on a bitmap that indicates the SSB is associated with the TRP.

The procedure 1200 may include performing a coarse time and frequency tracking estimation in 1206. In particular, the UE may perform a coarse time and frequency tracking estimation based on the SSB. In some embodiments, the UE may perform the coarse time and frequency estimation based on the determination that the UE is to operate in the HSV-SFN scheme 1.

The procedure 1200 may include performing a fine time and frequency tracking estimation in 1208. In particular, the UE may perform fine time and frequency tracking estimation based on the TRS associated with the TRP.

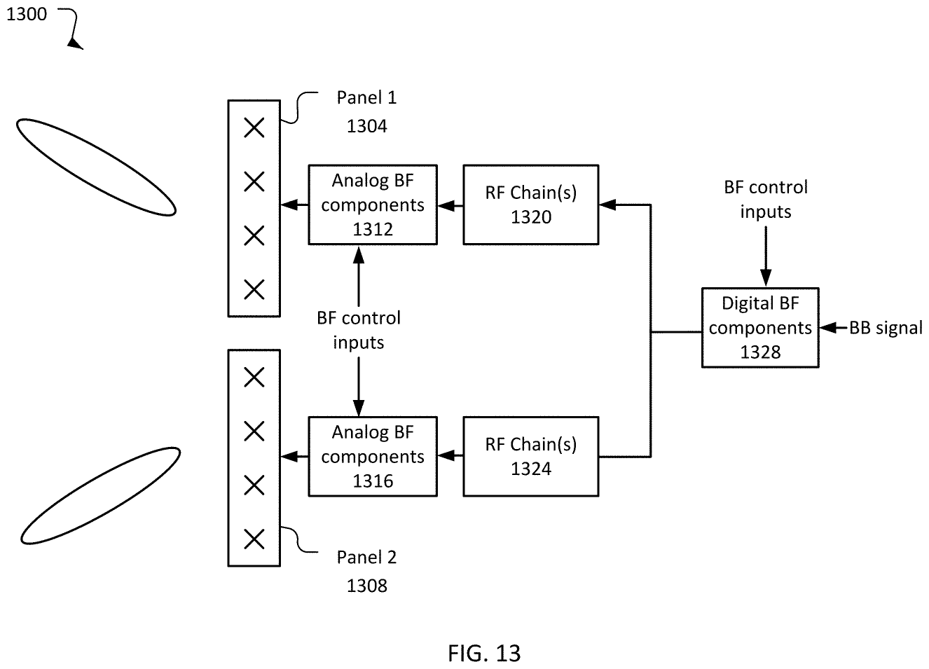

FIG. 13 illustrates example beamforming circuitry 1300 in accordance with some embodiments. The beamforming circuitry 1300 may include a first antenna panel, panel 1 1304, and a second antenna panel, panel 2 1308. Each antenna panel may include a number of antenna elements. Other embodiments may include other numbers of antenna panels.

Digital beamforming (BF) components 1328 may receive an input baseband (BB) signal from, for example, a baseband processor such as, for example, baseband processor 1404A of FIG. 14. The digital BF components 1328 may rely on complex weights to pre-code the BB signal and provide a beamformed BB signal to parallel radio frequency (RF) chains 1320/1324.

Each RF chain 1320/1324 may include a digital-to-analog converter to convert the BB signal into the analog domain; a mixer to mix the baseband signal to an RF signal; and a power amplifier to amplify the RF signal for transmission.

The RF signal may be provided to analog BF components 1312/1316, which may apply additionally beamforming by providing phase shifts in the analog domain. The RF signals may then be provided to antenna panels 1304/1308 for transmission.

In some embodiments, instead of the hybrid beamforming shown here, the beamforming may be done solely in the digital domain or solely in the analog domain.

In various embodiments, control circuitry, which may reside in a baseband processor, may provide BF weights to the analog/digital BF components to provide a transmit beam at respective antenna panels. These BF weights may be determined by the control circuitry to provide the directional provisioning of the serving cells as described herein. In some embodiments, the BF components and antenna panels may operate together to provide a dynamic phased-array that is capable of directing the beams in the desired direction.

FIG. 14 illustrates an example UE 1400 in accordance with some embodiments. The UE 1400 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices. In some embodiments, the UE 1400 may be a RedCap UE or NR-Light UE.

The UE 1400 may include processors 1404, RF interface circuitry 1408, memory/storage 1412, user interface 1416, sensors 1420, driver circuitry 1422, power management integrated circuit (PMIC) 1424, antenna structure 1426, and battery 1428. The components of the UE 1400 may be implemented as integrated circuits (ICs), portions thereof, discrete electronic devices, or other modules, logic, hardware, software, firmware, or a combination thereof. The block diagram of FIG. 14 is intended to show a high-level view of some of the components of the UE 1400. However, some of the components shown may be omitted, additional components may be present, and different arrangement of the components shown may occur in other implementations.

The components of the UE 1400 may be coupled with various other components over one or more interconnects 1432, which may represent any type of interface, input/output, bus (local, system, or expansion), transmission line, trace, optical connection, etc. that allows various circuit components (on common or different chips or chipsets) to interact with one another.

The processors 1404 may include processor circuitry such as, for example, baseband processor circuitry (BB) 1404A, central processor unit circuitry (CPU) 1404B, and graphics processor unit circuitry (GPU) 1404C. The processors 1404 may include any type of circuitry or processor circuitry that executes or otherwise operates computer-executable instructions, such as program code, software modules, or functional processes from memory/storage 1412 to cause the UE 1400 to perform operations as described herein.

In some embodiments, the baseband processor circuitry 1404A may access a communication protocol stack 1436 in the memory/storage 1412 to communicate over a 3GPP compatible network. In general, the baseband processor circuitry 1404A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1408.

The baseband processor circuitry 1404A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1412 may include one or more non-transitory, computer-readable media that includes instructions (for example, communication protocol stack 1436) that may be executed by one or more of the processors 1404 to cause the UE 1400 to perform various operations described herein. The memory/storage 1412 include any type of volatile or non-volatile memory that may be distributed throughout the UE 1400. In some embodiments, some of the memory/storage 1412 may be located on the processors 1404 themselves (for example, L1 and L2 cache), while other memory/storage 1412 is external to the processors 1404 but accessible thereto via a memory interface. The memory/storage 1412 may include any suitable volatile or non-volatile memory such as, but not limited to, dynamic random access memory (DRAM), static random access memory (SRAM), eraseable programmable read only memory (EPROM), electrically eraseable programmable read only memory (EEPROM), Flash memory, solid-state memory, or any other type of memory device technology.

The RF interface circuitry 1408 may include transceiver circuitry and radio frequency front module (RFEM) that allows the UE 1400 to communicate with other devices over a radio access network. The RF interface circuitry 1408 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1426 and proceed to filter and amplify (with a low-noise amplifier) the signal. The signal may be provided to a receiver of the transceiver that down-converts the RF signal into a baseband signal that is provided to the baseband processor of the processors 1404.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1426.

In various embodiments, the RF interface circuitry 1408 may be configured to transmit/receive signals in a manner compatible with NR access technologies.

The antenna 1426 may include antenna elements to convert electrical signals into radio waves to travel through the air and to convert received radio waves into electrical signals. The antenna elements may be arranged into one or more antenna panels. The antenna 1426 may have antenna panels that are omnidirectional, directional, or a combination thereof to enable beamforming and multiple input, multiple output communications. The antenna 1426 may include microstrip antennas, printed antennas fabricated on the surface of one or more printed circuit boards, patch antennas, phased array antennas, etc. The antenna 1426 may have one or more panels designed for specific frequency bands including bands in FR1 or FR2.

In some embodiments, the UE 1400 may include the beamforming circuitry 1300 (FIG. 13), where the beamforming circuitry 1300 may be utilized for communication with the UE 1400. In some embodiments, components of the UE 1400 and the beamforming circuitry may be shared. For example, the antennas 1426 of the UE may include the panel 1 1304 and the panel 2 1308 of the beamforming circuitry 1300.

The user interface circuitry 1416 includes various input/output (I/O) devices designed to enable user interaction with the UE 1400. The user interface 1416 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1400.

The sensors 1420 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1422 may include software and hardware elements that operate to control particular devices that are embedded in the UE 1400, attached to the UE 1400, or otherwise communicatively coupled with the UE 1400. The driver circuitry 1422 may include individual drivers allowing other components to interact with or control various input/output (I/O) devices that may be present within, or connected to, the UE 1400. For example, driver circuitry 1422 may include a display driver to control and allow access to a display device, a touchscreen driver to control and allow access to a touchscreen interface, sensor drivers to obtain sensor readings of sensor circuitry 1420 and control and allow access to sensor circuitry 1420, drivers to obtain actuator positions of electro-mechanic components or control and allow access to the electro-mechanic components, a camera driver to control and allow access to an embedded image capture device, audio drivers to control and allow access to one or more audio devices.

The PMIC 1424 may manage power provided to various components of the UE 1400. In particular, with respect to the processors 1404, the PMIC 1424 may control power-source selection, voltage scaling, battery charging, or DC-to-DC conversion.

In some embodiments, the PMIC 1424 may control, or otherwise be part of, various power saving mechanisms of the UE 1400. For example, if the platform UE is in an

RRC Connected state, where it is still connected to the RAN node as it expects to receive traffic shortly, then it may enter a state known as Discontinuous Reception Mode (DRX) after a period of inactivity. During this state, the UE 1400 may power down for brief intervals of time and thus save power. If there is no data traffic activity for an extended period of time, then the UE 1400 may transition off to an RRC Idle state, where it disconnects from the network and does not perform operations such as channel quality feedback, handover, etc. The UE 1400 goes into a very low power state and it performs paging where again it periodically wakes up to listen to the network and then powers down again. The UE 1400 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1428 may power the UE 1400, although in some examples the UE 1400 may be mounted deployed in a fixed location, and may have a power supply coupled to an electrical grid. The battery 1428 may be a lithium ion battery, a metal-air battery, such as a zinc-air battery, an aluminum-air battery, a lithium-air battery, and the like. In some implementations, such as in vehicle-based applications, the battery 1428 may be a typical lead-acid automotive battery.

FIG. 15 illustrates an example gNB 1500 in accordance with some embodiments. The gNB 1500 may include processors 1504, RF interface circuitry 1508, core network (CN) interface circuitry 1512, memory/storage circuitry 1516, and antenna structure 1526.

The components of the gNB 1500 may be coupled with various other components over one or more interconnects 1528.

The processors 1504, RF interface circuitry 1508, memory/storage circuitry 1516 (including communication protocol stack 1510), antenna structure 1526, and interconnects 1528 may be similar to like-named elements shown and described with respect to FIG. 14.

The CN interface circuitry 1512 may provide connectivity to a core network, for example, a 5th Generation Core network (5GC) using a 5GC-compatible network interface protocol such as carrier Ethernet protocols, or some other suitable protocol. Network connectivity may be provided to/from the gNB 1500 via a fiber optic or wireless backhaul. The CN interface circuitry 1512 may include one or more dedicated processors or FPGAs to communicate using one or more of the aforementioned protocols. In some implementations, the CN interface circuitry 1512 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Proposal 1.1

Example 1 may include a method, comprising determining, by a user equipment (UE) a configuration per-bandwidth part (BWP) or per-component carrier (CC) based on a radio resource control (RRC) communication received from a transmission and reception point (TRP), wherein the configuration is to configure the UE to operate according to a high speed vehicle-single frequency network (HSV-SFN) scheme 1 within a BWP or a CC, determining, based on a medium access control-control element (MAC-CE) received from the TRP, whether to activate a transmission configuration indicator (TCI) codepoint with a single TCI state or two TCI states, performing a channel estimation procedure to determine a Doppler shift based on the TCI codepoint, and utilizing the determined Doppler shift in decoding at least one signal received by the UE.

Example 2may include the method of example 1, wherein the at least one signal is received via a physical downlink shared channel (PDSCH) of the BWP or the CC.

Example 3 may include the method of example 1, wherein the UE is to determine the configuration per-CC, wherein the configuration is to configure the UE to operate according to the HSV-SFN scheme 1 within all BWPs of a CC.

Example 4 may include the method of example 1, wherein the UE is to determine the configuration per-BWP, the configuration is to configure the UE to operate according to the HSV-SFN scheme 1 within a first BWP of a CC, and the UE is further configured to operate according to a single-TRP scheme within a second BWP of the CC.

Example 5 may include the method of example 1, wherein the MAC-CE is a first MAC-CE, and wherein the method further comprises identifying an indication in a second MAC-CE or downlink control information (DCI) to switch activation of the TCI codepoint to the single TCI state or the two TCI states, and switching activation of the TCI codepoint based on the indication.

Example 6 may include the method of example 5, wherein switching activation of the TCI codepoint includes switching from a first bandwidth part (BWP) to a second BWP.

Proposal 1.1

Example 7 may include a method, comprising generating, by a base station, a radio resource control (RRC) communication to configure a user equipment (UE) to operate according to high speed vehicle-single frequency network (HSV-SFN) scheme 1 within a bandwidth part (BWP) or a component carrier (CC), determining whether the UE supports dynamic switching between HSV-SFN scheme 1 and single-transmission and reception point (TRP) scheme, and activating transmission configuration indicator (TCI) codepoint with a single TCI state or two TCI states based on determination of whether the UE supports dynamic switching between HSV-SFN scheme 1 and single-TRP scheme.

Example 8 may include the method of example 7, further comprising determining, based on an indication received from the UE, that the UE supports the HSV-SFN scheme 1, wherein the TRP is to generate the RRC based on the indication.

Example 9 may include the method of example 7, wherein determining whether the UE supports dynamic switching comprises determining that the UE does not support dynamic switching, and wherein activating the TCI codepoint comprises activating the TCI codepoint with the two TCI states.

Example 10 may include the method of example 7, further comprising generating a medium access control-control element (MAC-CE) that indicates whether the TCI codepoint is to be activated with the single TCI state or the two TCI states, and providing the MAC-CE to the UE to configure the UE with the TCI codepoint.

Example 11 may include the method of example 10, wherein the MAC-CE further indicates a particular component carrier (CC) for which the TCI codepoint is to be activated.

Example 12 may include the method of example 10, wherein the MAC-CE further indicates a particular bandwidth part (BWP) of a component carrier (CC) for which the TCI codepoint is to be activated.

Proposal 1.2:

Example 13 may include a method of operating a base station, the method comprising determining whether a UE supports mixed CORESET operation for high speed vehicle-single frequency network (HSV-SFN), and configuring a plurality of CORESETs of an active BWP based on whether the UE supports mixed CORESET operation for HSV-SFN.

Example 14 may include the method of example 13, wherein determining whether the UE supports mixed CORESET operation for HSV-SFN comprises receiving a UE capability report that indicates the UE supports HSV-SFN, or receiving a UE capability report that indicates the UE supports the mixed CORESET operation.

Example 15 may include the method of example 14, wherein the UE capability report indicates that the UE supports HSV-SFN for a physical downlink control channel (PDCCH).

Proposal 1.3

Example 16 may include the method of example 13, wherein determining whether the UE supports mixed CORESET operation comprises determining that the UE does not support mixed CORESET operation, and wherein the method further comprises transmitting a medium access control-control element (MAC-CE) to activate one or more CORESETs of the active BWP with a number of TCI states, the number of TCI states being one or two.

Proposal 1.4:

Example 17 may include a method of operating a user equipment (UE), comprising determining a synchronization signal/physical broadcast channel block (SSB) is associated with a transmission and reception point (TRP), performing a coarse time and frequency tracking estimation based on the SSB, and performing fine time and frequency tracking estimation based on a tracking reference signal (TRS) associated with the TRP.

Example 18 may include the method of example 17, wherein determining the SSB is associated with the TRP includes determining that the SSB is configured as a quasi co-location (QCL) source of the TRS.

Example 19 may include the method of example 17, wherein determining the SSB is associated with the TRP comprises determining the SSB is associated with the TRP based on a medium access control-control element (MAC-CE) received by the UE.

Example 20 may include the method of example 17, wherein determining the SSB is associated with the TRP comprises determining the SSB is associated with the TRP based on a bitmap that indicates the SSB is associated with the TRP.

Example 21 may include the method of example 17, further comprising determining that the UE is to operate in high speed vehicle-single frequency network (HSV-SFN) scheme 1, wherein the UE is to perform the coarse time and frequency estimation based on the determination that the UE is to operate in the HSV-SFN scheme 1.

Proposal 1.1:

Example 22 may include a method for determination of a Doppler shift, comprising determining, by a user equipment (UE), that the UE is to operate in high speed vehicle-single frequency network (HSV-SFN) scheme 1 within a bandwidth part (BWP) or a component carrier (CC) for determination by the UE of the Doppler shift based on a radio resource control (RRC) communication, determining, by the UE, that a transmission configuration indicator (TCI) codepoint is to be activated with a single TCI state or two TCI states based on a medium access control-control element (MAC-CE), activating, by the UE, the TCI codepoint with the single TCI state or the two TCI states determined, and determining, by the UE, the Doppler shift based on the TCI codepoint.

Example 23 may include the method of example 22, further comprising utilizing the determined Doppler shift to decode at least one signal received by the UE.

Example 24 may include the method of example 23, wherein the at least one signal is received via a physical downlink shared channel (PDSCH).

Example 25 may include the method of example 22, wherein activating the TCI codepoint comprises activating the TCI codepoint for the CC.

Example 26 may include the method of example 22, wherein activating the TCI codepoint comprises activating the TCI codepoint for the BWP.

Example 27 may include the method of example 22, wherein the MAC-CE is a first MAC-CE, and wherein the method further comprises identifying, by the UE, an indication in a second MAC-CE or downlink control information (DCI) to switch activation of the TCI codepoint between the single TCI state and the two TCI states, and switching, by the UE, activation of the TCI codepoint based on the indication.

Proposal 2.1

Example 28 may include a method of operating a user equipment (UE) comprising determining, based on one or more signals from a transmission and reception point (TRP), that the TRP is to perform high speed vehicle-single frequency network (HSV-SFN) pre-compensation, determining, based on a medium access control-control element (MAC-CE) from the TRP, one or two transmission configuration indicator (TCI) states for configuration of a control resource set (CORESET) in a carrier component (CC), the MAC-CE to indicate quasi co-location (QCL) properties for the one or two TCI states, and configuring, based on the determination of the one or two TCI states, the CORESET with the QCL properties.

Example 29 may include the method of example 28, wherein the one or two TCI states comprise two TCI states, wherein first QCL properties for a first of the two TCI states comprises QCL-TypeA properties, and wherein second QCL properties for a second of the two TCI states comprises QCL properties of average delay and delay spread.

Example 30 may include the method of example 29, wherein the QCL-TypeA properties comprises QCL properties of average delay, delay spread, Doppler shift, and Doppler spread.

Example 31 may include the method of example 29, further comprising identifying the MAC-CE or radio resource control (RRC) from the TRP that indicates that the second QCL properties do not include Doppler shift and Doppler spread.

Proposal 2.2

Example 32 may include the method of example 28, further comprising providing an indication whether the UE supports mixed physical downlink control channel (PDCCH) monitoring mode.

Example 33 may include the method of example 32, wherein providing the indication includes providing an indication that the UE does not support the mixed PDCCH monitoring mode, and wherein determining one or two TCI states for configuration of the CORESET includes determining to activate the CORESET with two TCI states based on the MAC-CE.

Example 34 may include the method of example 32, wherein the CORESET is a first CORESET, wherein determining the one or two TCI states for configuration of the first CORESET includes determining two TCI states for configuration of the first CORESET, wherein configuring the first CORESET includes configuring the first CORESET with the two TCI states, and wherein the method further comprises determining, based on the MAC-CE, one TCI state for configuration of a second CORESET, and configuring, based on the determination of the one TCI state, the second CORESET with the one TCI state.

Example 35 may include the method of example 28, wherein the HSV-SFN pre-compensation comprises HSV-SFN pre-compensation for physical downlink control channel (PDCCH).

Proposal 2.3

Example 36 may include a method of operating a user equipment (UE), comprising determining, based on one or more signals from a transmission and reception point (TRP), that the TRP is to perform high speed vehicle-single frequency network (HSV-SFN) with pre-compensation, determining, based on a medium access control-control element (MAC-CE) from the TRP, two transmission configuration indicator (TCI) states for configuration of a TCI codepoint, the MAC-CE to indicate quasi co-location (QCL) properties for two TCI states, and configuring, based on the determination of the two TCI states, the TCI codepoint with the two TCI states.

Example 37 may include the method of example 36, wherein determining the two TCI states includes determining a first TCI state that comprises QCL-TypeA properties for the TCI and a second TCI state that comprises QCL properties of average delay and delay spread.

Example 38 may include the method of example 37, wherein the QCL-TypeA comprises QCL properties of average delay, delay spread, Doppler shift, and Doppler spread.

Example 39 may include the method of example 36, wherein the one or more signals comprise radio resource control (RRC) that indicates that the TRP is configured for HSV-SFN with pre-compensation.

Proposal 2.4

Example 40 may include the method of example 36, further comprising indicating that the UE does not support dynamic switching of HSV-SFN with pre-compensation, and wherein the MAC-CE indicates the two TCI states for configuration of the TCI codepoint based on the indication that the UE does not support dynamic switching of HSV-SFN with pre-compensation.

Proposal 2.5

Example 41 may include a method of operating a user equipment (UE), comprising determining, based on a radio resource control (RRC) communication, that the UE is to operate in high speed vehicle-single frequency network (HSV-SFN) with pre-compensation, determining a synchronization signal/physical broadcast channel block (SSB) is associated with a transmission and reception point (TRP), and performing course time and frequency estimation based on the SSB with the HSV-SFN with pre-compensation.

Example 42 may include the method of example 41, further comprising determining, based at least in part on a medium access control-control element (MAC-CE), quasi co-location (QCL) properties corresponding to the SSB.

Example 43 may include the method of example 42, wherein the QCL properties comprise a first set of QCL properties that comprise average delay, delay spread, Doppler shift, and Doppler spread, or a second set of QCL properties that comprise average delay and delay spread.

Example 44 may include the method of example 41, wherein determining the SSB is associated with the TRP comprises determining the SSB is configured as a quasi co-location (QCL) source of a tracking reference signal (TRS) associated with the TRP, and wherein the method further comprises performing fine time and frequency estimation based on the TRS.

Example 45 may include the method of example 41, wherein determining the SSB is associated with the TRP comprises determining the SSB is associated with the TRP based on a medium access control-control element (MAC-CE) received by the UE.

Example 46 may include the method of example 41, wherein determining the SSB is associated with the TRP comprises determining the SSB is associated with the TRP based on a bitmap that indicates the SSB is associated with the TRP.

Proposal 3.1

Example 47 may include a method to operate a user equipment (UE), comprising determining, based on a medium access control-control element (MAC-CE) received from a first transmission and reception point (TRP), a high speed vehicle-single frequency network (HSV-SFN) scheme, determining, based on the MAC-CE, a plurality of component carriers (CCs) to be configured with the HSV-SFN scheme, and configuring at least a portion of the plurality of CCs with the HSV-SFN scheme, the HSV-SFN scheme to be utilized by the at least the portion of the plurality of CCs to estimate a Doppler shift.

Example 48 may include the method of example 47, further comprising configuring, based on radio resource control (RRC) received from the TRP, one or more CC lists, wherein each of the one or more CC lists comprise corresponding CCs, and wherein determining the plurality of CCs to be configured with the HSV-SFN scheme comprises determining the plurality of CCs to be configured with the HSV-SFN scheme based on the one or more CC lists.

Example 49 may include the method of example 48, wherein the one or more CC lists are orthogonal.

Example 50 may include the method of example 47, further comprising determining, based on the MAC-CE, one or more transmission configuration indicator (TCI) codepoints to be activated, and activating, based on the determination of the one or more TCI codepoints, the one or more TCI codepoints.

Example 51 may include the method of example 47, further comprising determining a first portion of the plurality of CCs that support the HSV-SFN scheme and a second portion of the plurality of CCs that do not support the HSV-SFN scheme, wherein configuring the at least the portion of the plurality of CCs with the HSV-SFN scheme comprises configuring the first portion of the plurality of CCs with the HSV-SFN scheme and configuring the second portion of the plurality of CCs without the HSV-SFN scheme.

Example 52 may include the method of example 51, further comprising activating the second portion of the plurality of CCs with a single TCI state.

Example 53 may include the method of example 47, wherein the at least the portion of the plurality of CCs are to be configured for a physical downlink shared channel (PDSCH).

Proposal 3.2

Example 54 may include a method of operating a base station, comprising generating a common radio network temporary identifier (RNTI), providing the common RNTI to a plurality of user equipments (UEs), the provision of the common RNTI to cause the plurality of UEs to be configured with the common RNTI, and providing downlink control information (DCI) to at least the plurality of UEs, the DCI to indicate a high speed vehicle-single frequency network (HSV-SFN) scheme for configuration by the plurality of UEs.

Example 55 may include the method of example 54, wherein the DCI comprises DCI format 1_1 or DCI format 1_2.

Example 56 may include the method of example 54, wherein the DCI is divided into different blocks, and wherein the further comprises providing a mapping of corresponding blocks of the DCI to the plurality of UEs, wherein the mapping indicates corresponding blocks of the DCI for which each of the plurality UEs is to utilize to determine the HSV-SFN scheme to be configured.

Targeted

Example 57 may include a method of operating a user equipment (UE), the method comprising determining a configuration per-bandwidth part (BWP) based on a radio resource control (RRC) communication received from a transmission and reception point (TRP), wherein the configuration is to configure the UE to operate according to a high speed vehicle-single frequency network (HSV-SFN) scheme 1 within a BWP, determining, based on a medium access control-control element (MAC-CE) received from the TRP, one or two transmission configuration indicator (TCI) states for configuration of a control resource set (CORESET), and configuring, based on the determination of the one or two TCI states, the CORESET within the BWP.

Example 58 may include the method of example 57, wherein the one or two TCI states comprise two TCI states.

Example 59 may include the method of example 57, wherein the method further comprises determining, based on the MAC-CE, whether to activate a TCI codepoint with the one or two transmission TCI states, performing a channel estimation procedure to determine a Doppler shift based on the TCI codepoint, and utilizing the determined Doppler shift in decoding at least one signal received by the UE.

Example 60 may include the method of example 59, wherein the at least one signal is received via a physical downlink shared channel (PDSCH) of the BWP.

Example 61 may include the method of example 59, wherein the MAC-CE is a first MAC-CE, and wherein the method further comprises identifying an indication in a second MAC-CE or downlink control information (DCI) to switch activation of the TCI codepoint to the one or two TCI states, and switching activation of the TCI codepoint based on the indication.

Example 62 may include the method of example 61, wherein switching activation of the TCI codepoint comprises switching from a first BWP to a second BWP.

Example 63 may include the method of example 57, wherein the BWP is a first BWP, and wherein configuring the CORESET comprises configuring the UE to operate according to the HSV-SFN scheme 1 within the first BWP and to operate according to a single-TRP scheme within a second BWP.

Example 64 may include a method of operating a user equipment (UE), the method comprising determining, based on one or more signals from a transmission and reception point (TRP), that pre-compensation is to be performed for the UE, determining, based on a medium access control-control element (MAC-CE) from the TRP, one or two transmission configuration indicator (TCI) states for configuration of a control resource set (CORESET), and configuring, based on the determination of the one or two TCI states, the CORESET.

Example 65 may include the method of example 64, wherein the one or two TCI states comprise two TCI states.

Example 66 may include the method of example 64, wherein the MAC-CE indicates quasi co-location (QCL) properties for the one or two TCI states.

Example 67 may include the method of example 64, wherein the one or two TCI states comprise two TCI states, wherein the MAC-CE includes a first Doppler shift and a first Doppler spread for a first of the two TCI states, and wherein the MAC-CE drops a second Doppler shift and a second Doppler spread for a second of the two TCI states.

Example 68 may include the method of example 64, wherein the one or two TCI states comprise two TCI states, wherein first quasi co-location (QCL) properties for a first of the two TCI states comprise QCL-TypeA properties, and wherein second QCL properties for a second of the two TCI states comprises QCL properties of average delay and delay spread.

Example 69 may include the method of example 68, wherein the QCL-TypeA properties comprise QCL properties of average delay, delay spread, Doppler shift, and Doppler spread.

Example 70 may include the method of example 64, wherein the pre-compensation comprises high speed vehicle-single frequency network (HSV-SFN) pre-compensation.

Example 71 may include a method of operating a user equipment (UE), the method comprising storing configuration information for a configuration, determining a configuration per-bandwidth part (BWP) based on a radio resource control (RRC) communication received from a transmission and reception point (TRP), wherein the configuration is to configure the UE to operate with pre-compensation within a BWP, determining, based on a medium access control-control element (MAC-CE) received from the TRP, one or two transmission configuration indicator (TCI) states for configuration of a control resource set (CORESET), and configuring, based on the determination of the one or two TCI states, the CORESET within the BWP.

Example 72 may include the method of example 71, wherein the one or two TCI states comprise two TCI states.

Example 73 may include the method of example 71, wherein the MAC-CE indicates quasi co-location (QCL) properties for the one or two TCI states.

Example 74 may include the method of example 71, wherein configuring the CORESET comprises configuring the CORESET with an RRC parameter based on the BWP.

Example 75 may include the method of example 71, wherein the pre-compensation comprises high speed vehicle-single frequency network (HSV-SFN) pre-compensation.

Example 76 may include the method of example 71, wherein the one or two TCI states comprise two TCI states, and wherein to determine the one or two TCI states comprises to determine a first TCI state that comprises QCL-TypeA properties for the TCI and a second TCI state that comprises QCL properties of average delay and delay spread.

Example 77 may include a method of operating a base station, the method comprising determining a bandwidth part (BWP) for a component carrier (CC) to be configured with high speed vehicle-single frequency network (HSV-SFN) scheme 1, generating a radio resource control (RRC) communication that indicates the BWP for the CC is to be configured with HSV-SFN scheme 1, transmitting the RRC communication to a user equipment (UE) to configure the UE with HSV-SFN scheme 1, generating a medium access control-control element (MAC-CE) that indicates one or two transmission configuration indicator (TCI) states for configuration of a control resource set (CORESET), and transmitting the MAC-CE to the UE to configure the CORESET within the BWP.

Example 78 may include the method of example 77, wherein the method further comprises receiving, from the UE, an indication that the UE supports dynamic switching, wherein the MAC-CE indicates one or two TCI states based on the indication that the UE supports dynamic switching.

Example 79 may include the method of example 77, wherein the one or two TCI states comprise two TCI states.

Example 80 may include the method of example 77, wherein the method further comprises receiving, from the UE, an indication that the UE does not support dynamic switching, wherein the one or two TCI states comprise two TCI states based on the indication that the UE does not support dynamic switching.

Example 81 may include the method of example 77, wherein the BWP is a first BWP, wherein the RRC communication indicates configurations for up to four BWPs for the CC.

Example 82 may include an apparatus comprising means to perform one or more elements of a method described in or related to any of examples 1-81, or any other method or process described herein.

Example 83 may include one or more non-transitory computer-readable media comprising instructions to cause an electronic device, upon execution of the instructions by one or more processors of the electronic device, to perform one or more elements of a method described in or related to any of examples 1-81, or any other method or process described herein.

Example 84 may include an apparatus comprising logic, modules, or circuitry to perform one or more elements of a method described in or related to any of examples 1-81, or any other method or process described herein.

Example 85 may include a method, technique, or process as described in or related to any of examples 1-81, or portions or parts thereof

Example 86 may include an apparatus comprising: one or more processors and one or more computer-readable media comprising instructions that, when executed by the one or more processors, cause the one or more processors to perform the method, techniques, or process as described in or related to any of examples 1-81, or portions thereof

Example 87 may include a signal as described in or related to any of examples 1-81, or portions or parts thereof.

Example 88 may include a datagram, information element, packet, frame, segment, PDU, or message as described in or related to any of examples 1-81, or portions or parts thereof, or otherwise described in the present disclosure.

Example 89 may include a signal encoded with data as described in or related to any of examples 1-81, or portions or parts thereof, or otherwise described in the present disclosure.

Example 90 may include a signal encoded with a datagram, IE, packet, frame, segment, PDU, or message as described in or related to any of examples 1-81, or portions or parts thereof, or otherwise described in the present disclosure.

Example 91 may include an electromagnetic signal carrying computer-readable instructions, wherein execution of the computer-readable instructions by one or more processors is to cause the one or more processors to perform the method, techniques, or process as described in or related to any of examples 1-81, or portions thereof.

Example 92 may include a computer program comprising instructions, wherein execution of the program by a processing element is to cause the processing element to carry out the method, techniques, or process as described in or related to any of examples 1-81, or portions thereof.

Example 93 may include a signal in a wireless network as shown and described herein.

Example 94 may include a method of communicating in a wireless network as shown and described herein.

Example 95 may include a system for providing wireless communication as shown and described herein.

Example 96 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method of operating a user equipment (UE), the method comprising:
determining a configuration per-bandwidth part (BWP) based on a radio resource control (RRC) communication received from a transmission and reception point (TRP), wherein the configuration is to configure the UE to operate according to a high speed vehicle-single frequency network (HSV-SFN) scheme 1 within a BWP;
determining, based on a medium access control-control element (MAC-CE) received from the TRP, one or two transmission configuration indicator (TCI) states for configuration of a control resource set (CORESET); and
configuring, based on the determination of the one or two TCI states, the CORESET within the BWP.

2. The method of claim 1, wherein the one or two TCI states comprise two TCI states.

3. The method of claim 1, wherein the method further comprises:
determining, based on the MAC-CE, whether to activate a TCI codepoint with the one or two transmission TCI states;
performing a channel estimation procedure to determine a Doppler shift based on the TCI codepoint; and
utilizing the determined Doppler shift in decoding at least one signal received by the UE.

4. The method of claim 3, wherein the at least one signal is received via a physical downlink shared channel (PDSCH) of the BWP.

5. The method of claim 3, wherein the MAC-CE is a first MAC-CE, and wherein the method further comprises:
identifying an indication in a second MAC-CE or downlink control information (DCI) to switch activation of the TCI codepoint to the one or two TCI states; and
switching activation of the TCI codepoint based on the indication.

6. The method of claim 5, wherein switching activation of the TCI codepoint comprises switching from a first BWP to a second BWP.

7. The method of claim 1, wherein the BWP is a first BWP, and wherein configuring the CORESET comprises configuring the UE to operate according to the HSV-SFN scheme 1 within the first BWP and to operate according to a single-TRP scheme within a second BWP.

8. One or more non-transitory, computer-readable media having instructions that, when executed by one or more processors, cause a user equipment (UE) to:
determine, based on one or more signals from a transmission and reception point (TRP), that pre-compensation is to be performed for the UE;
determine, based on a medium access control-control element (MAC-CE) from the TRP, one or two transmission configuration indicator (TCI) states for configuration of a control resource set (CORESET); and
configure, based on the determination of the one or two TCI states, the CORESET.

9. The one or more non-transitory, computer-readable media of claim 8, wherein the one or two TCI states comprise two TCI states.

10. The one or more non-transitory, computer-readable media of claim 8, wherein the MAC-CE indicates quasi co-location (QCL) properties for the one or two TCI states.

11. The one or more non-transitory, computer-readable media of claim 8, wherein the one or two TCI states comprise two TCI states, wherein the MAC-CE includes a first Doppler shift and a first Doppler spread for a first of the two TCI states, and wherein the MAC-CE drops a second Doppler shift and a second Doppler spread for a second of the two TCI states.

12. The one or more non-transitory, computer-readable media of claim 8, wherein the one or two TCI states comprise two TCI states, wherein first quasi co-location (QCL) properties for a first of the two TCI states comprise QCL-TypeA properties, and wherein second QCL properties for a second of the two TCI states comprises QCL properties of average delay and delay spread.

13. The one or more non-transitory, computer-readable media of claim 12, wherein the QCL-TypeA properties comprise QCL properties of average delay, delay spread, Doppler shift, and Doppler spread.

14. The one or more non-transitory, computer-readable media of claim 8, wherein the pre-compensation comprises high speed vehicle-single frequency network (HSV-SFN) pre-compensation.

15. A user equipment (UE), comprising:
memory to store configuration information for a configuration; and
processing circuitry coupled with the memory, the processing circuitry to:
determine a configuration per-bandwidth part (BWP) based on a radio resource control (RRC) communication received from a transmission and reception point (TRP), wherein the configuration is to configure the UE to operate with pre-compensation within a BWP;
determine, based on a medium access control-control element (MAC-CE) received from the TRP, one or two transmission configuration indicator (TCI) states for configuration of a control resource set (CORESET); and
configure, based on the determination of the one or two TCI states, the CORESET within the BWP.

16. The UE of claim 15, wherein the one or two TCI states comprise two TCI states.

17. The UE of claim 15, wherein the MAC-CE indicates quasi co-location (QCL) properties for the one or two TCI states.

18. The UE of claim 15, wherein configuring the CORESET comprises configuring the CORESET with an RRC parameter based on the BWP.

19. The UE of claim 15, wherein the pre-compensation comprises high speed vehicle-single frequency network (HSV-SFN) pre-compensation.

20. The UE of claim 15, wherein the one or two TCI states comprise two TCI states, and wherein to determine the one or two TCI states comprises to determine a first TCI state that comprises QCL-TypeA properties for the TCI and a second TCI state that comprises QCL properties of average delay and delay spread.

21. A method of operating a base station, the method comprising:
determining a bandwidth part (BWP) for a component carrier (CC) to be configured with high speed vehicle-single frequency network (HSV-SFN) scheme 1;
generating a radio resource control (RRC) communication that indicates the BWP for the CC is to be configured with HSV-SFN scheme 1;
transmitting the RRC communication to a user equipment (UE) to configure the UE with HSV-SFN scheme 1;
generating a medium access control-control element (MAC-CE) that indicates one or two transmission configuration indicator (TCI) states for configuration of a control resource set (CORESET); and
transmitting the MAC-CE to the UE to configure the CORESET within the BWP.

22. The method of claim 21, wherein the method further comprises:
receiving, from the UE, an indication that the UE supports dynamic switching, wherein the MAC-CE indicates one or two TCI states based on the indication that the UE supports dynamic switching.

23. The method of claim 21, wherein the one or two TCI states comprise two TCI states.

24. The method of claim 21, wherein the method further comprises:
receiving, from the UE, an indication that the UE does not support dynamic switching, wherein the one or two TCI states comprise two TCI states based on the indication that the UE does not support dynamic switching.

25. The method of claim 21, wherein the BWP is a first BWP, wherein the RRC communication indicates configurations for up to four BWPs for the CC.
